(19) United States
(12) Patent Application Publication
(10) Pub. No.: US 2025/0043836 A1
(43) Pub. Date: Feb. 6, 2025

(54) FLOATING DISC BRAKE DEVICE

(71) Applicant: AKEBONO BRAKE INDUSTRY CO., LTD., Chuo-ku, Tokyo (JP)

(72) Inventor: Tatsuya SUZUKI, Tokyo (JP)

(73) Assignee: AKEBONO BRAKE INDUSTRY CO., LTD., Chuo-ku, Tokyo (JP)

(21) Appl. No.: 18/719,999

(22) PCT Filed: Dec. 16, 2022
(86) PCT No.: PCT/JP2022/046442

§ 371 Date: Jun. 14, 2024

(30) Foreign Application Priority Data
Dec. 17, 2021 (JP) 2021-205027

(51) Int. Cl. F16D 55/226; F16D 55/00; F16D 65/00; F16D 65/12

(52) U.S. Cl. CPC F16D 55/2262; F16D 65/0056; F16D 65/0068; F16D 65/122; F16D 2055/0008; F16D 2055/0016

(57) ABSTRACT

A floating disc brake device includes: an inner pad; an outer pad; a support; and a caliper body. The support includes an inner guide portion configured to support the inner pad such that the inner pad is movable in an axial direction, and an outer guide portion configured to support the outer pad such that the outer pad is movable in the axial direction, on each of both circumferentially outer side portions. The caliper body includes a cylinder, and includes an inner body portion and an outer body portion. The outer body portion includes a through hole that opens only in the axial direction in at least one of a portion facing the outer guide portion in the axial direction and a portion facing a vicinity of the outer guide portion in the axial direction.

### TECHNICAL FIELD

The present invention relates to a floating disc brake device.

### BACKGROUND ART

FIG. 38 shows a floating disc brake device 100 having a structure in the related art described in JPS57-1922U (Patent Literature 1).

The disc brake device 100 includes a support 101, a caliper body 102, an inner pad 103, and an outer pad 104. During braking, by displacing the caliper body 102 supported by the support 101 in an axial direction, so that a rotor 105 that rotates together with a wheel is clamped between the inner pad 103 and the outer pad 104 from both axial sides.

In the present specification and claims, an “axial direction”, a “radial direction”, and a “circumferential direction” refer to an axial direction, a radial direction, and a circumferential direction of a disc-shaped rotor that rotates together with a wheel, unless otherwise specified. In addition, in a state where a disc brake device is attached to a vehicle body, an outer side in a width direction of the vehicle body is referred to as an axially outer side, and a central side in the width direction of the vehicle body is referred to as an axially inner side. In addition, a circumferentially central side of the disc brake device is referred to as a circumferentially inner side, and both circumferential sides of the disc brake device are referred to as circumferentially outer sides. Further, a rotation-in side refers to a side where the rotor enters a caliper body, and a rotation-out side refers to a side to which the rotor exits from the caliper body.

The support 101 is fixed to a suspension device, and includes a pair of guide portions 106 each having an inverted U-shape as viewed in a circumferential direction, and a circumferential connection portion 107 that connects the pair of guide portions 106 in the circumferential direction.

Each of the pair of guide portions 106 includes an inner guide portion 108, an outer guide portion 109, and a caliper guide portion 110.

The caliper guide portion 110 connects radially outer side ends of the inner guide portion 108 and the outer guide portion 109 in the axial direction. A support hole 111 is formed inside the caliper guide portion 110. The support hole 111 opens in an axially inner side surface of the caliper guide portion 110.

The caliper body 102 includes a bifurcated outer body portion 112 on an axially outer side portion and an inner body portion 113 on an axially inner side portion. The inner body portion 113 includes a cylinder 114. A piston 115 is fitted into the cylinder 114 so as to be movable in the axial direction. The caliper body 102 is supported to be movable in the axial direction with respect to the support 101 using a pair of slide pins 116. Each of the slide pins 116 has a base end portion fixed to the caliper body 102 and a front half portion slidably inserted into the support hole 111 provided in the caliper guide portion 110.

The inner pad 103 is disposed on an axially inner side of the rotor 105, and is supported to be movable in the axial direction with respect to the pair of the inner guide portions 108. The outer pad 104 is disposed on the axially outer side of the rotor 105, and is supported to be movable in the axial direction with respect to the pair of outer guide portions 109.

When braking is performed, pressure oil is fed from a master cylinder to the cylinder 114, and the inner pad 103 is pressed against an axially inner side surface of the rotor 105 by the piston 115 from an upper side to a lower side in FIG. 38. Thus, the caliper body 102 moves on the upper side in FIG. 38 based on the sliding of the slide pin 116 and the support hole 111 due to the reaction of a pressing force. The outer body portion 112 presses the outer pad 104 against an axially outer side surface of the rotor 105. As a result, the rotor 105 is strongly clamped from both axial sides, and braking is performed.

### CITATION LIST

### Patent Literature

Patent Literature 1: JPS57-1922U

### SUMMARY OF INVENTION

### Technical Problem

In recent years, even in the floating disc brake device, importance of designability is increased, and it is desired to secure a design surface having the substantially same size as that of an opposed piston type disc brake device.

In view of such circumstances, it is considered that, in a state where the disc brake device is attached to the vehicle body, a circumferential dimension of an outer body portion (a claw portion) constituting the caliper body, which is visible from an outside, is increased, and a pair of guide portions constituting the support is covered with the outer body portion from the axially outer side. In this way, by increasing the circumferential dimension of the outer body portion, a design surface formed by an axially outer side surface of the outer body portion can be increased.

However, in a case where the pair of guide portions of the support are covered with the outer body portion from the axially outer side, when wear of the inner pad and the outer pad progresses and the caliper body moves to an axially inner side with respect to the support, a gap between the outer guide portion and the outer body portion constituting the guide portion is reduced. Therefore, the outer guide portion and the outer body portion easily interfere with each other during braking.

A pad clip made of a metal plate is often attached to the outer guide portion in order to enable smooth axial movement of the outer pad, and depending on a shape of the pad clip to be used, an axially outer side portion of the pad clip may be disposed to protrude to the axially outer side with respect to the outer guide portion. Therefore, when such a pad clip is used, the pad clip and the outer body portion easily interfere with each other.

The present invention has been made to solve the above problems, and an object thereof is to provide a floating disc brake device capable of suppressing interference between an outer guide portion of a support or a pad clip attached to the outer guide portion and an outer body portion of a caliper body.

### Solution to Problem

A floating disc brake device according to one aspect of the present invention includes an inner pad, an outer pad, a support, and a caliper body.

The inner pad is configured to be disposed on an axially inner side of a rotor.

The outer pad is configured to be disposed on an axially outer side of the rotor.

The support is configured to be fixed to a vehicle body, and configured to support the inner pad and the outer pad such that the inner pad and the outer pad are movable in an axial direction.

The caliper body is supported to be movable in the axial direction with respect to the support.

The support includes an inner guide portion configured to support the inner pad such that the inner pad is movable in the axial direction, and an outer guide portion configured to support the outer pad such that the outer pad is movable in the axial direction, on each of both circumferentially outer side portions.

The caliper body includes a cylinder, and includes an inner body portion configured to be disposed on the axially inner side of the rotor and an outer body portion configured to press the outer pad during braking.

The outer body portion includes a through hole that opens only in the axial direction in at least one of a portion facing the outer guide portion in the axial direction and a portion facing a vicinity of the outer guide portion in the axial direction.

The floating disc brake device according to one aspect of the present invention further includes a pad clip disposed between the outer pad and the outer guide portion, and a portion of the pad clip may be configured to be inserted into the through hole.

A portion of the pad clip that protrudes most to an axially outer side may be inserted into the through hole.

In the floating disc brake device according to one aspect of the present invention, the through hole may have a shape and a size into which the portion of the pad clip can be inserted substantially without a gap.

In the floating disc brake device according to one aspect of the present invention, the outer pad may include a protruding ear portion that protrudes in a circumferential direction, the outer guide portion may include a guide recessed groove engageable with the ear portion, and the through hole may be provided in a portion facing an internal space of the guide recessed groove in the axial direction.

In the floating disc brake device according to one aspect of the present invention, the through hole may have a circumferential dimension larger than a radial dimension.

In the floating disc brake device according to one aspect of the present invention, the through hole may have a substantially polygonal opening shape as viewed in the axial direction.

In this case, the opening shape (a cross-sectional shape) of the through hole may be, for example, a rectangle (including a square), a trapezoid, a pentagonal shape, or a parallelogram shape.

In the floating disc brake device according to one aspect of the present invention, the through hole may have a cross-sectional shape that changes according to an axial position.

In the floating disc brake device according to one aspect of the present invention, the outer body portion may have a circumferential dimension larger than a circumferential dimension of the support.

In the floating disc brake device according to one aspect of the present invention, a recessed groove connected to an opening portion of the through hole may be provided on an axially outer side surface of the outer body portion.

In the floating disc brake device according to one aspect of the present invention, the recessed groove may extend in a circumferential direction.

In the floating disc brake device according to one aspect of the present invention, the outer body portion may have a substantially arcuate shape as viewed in the axial direction, and the recessed groove may open to a radially inner side surface or a radially outer side surface of the outer body portion.

In the floating disc brake device according to one aspect of the present invention, a bottom surface of the recessed groove may be a convex curved surface that is curved in an arc shape such that a width direction intermediate portion protrudes to an axially outer side with respect to both width direction side portions.

In the floating disc brake device according to one aspect of the present invention, a bottom surface of the recessed groove may be a concave curved surface that is curved in an arc shape such that a width direction intermediate portion is recessed on an axially inner side with respect to both width direction side portions.

In the floating disc brake device according to one aspect of the present invention, a central axis of the through hole and a central axis of the rotor may be parallel to each other.

In the floating disc brake device according to one aspect of the present invention, the outer body portion may have two of the through holes.

### Advantageous Effects of Invention

According to the present invention, it is possible to realize a floating disc brake device capable of suppressing interference between an outer guide portion of a support or a pad clip attached to the outer guide portion and an outer body portion of a caliper body.

### BRIEF DESCRIPTION OF DRAWINGS

FIG. 1 is a front view of a disc brake device according to a first embodiment as viewed from an axially outer side.

FIG. 2 is a rear view of the disc brake device according to the first embodiment as viewed from the axially inner side.

FIG. 3 is a plan view of the disc brake device according to the first embodiment as viewed from a radially outer side.

FIG. 4 is a bottom view of the disc brake device according to the first embodiment as viewed from the radially inner side.

FIG. 5 is a side view of the disc brake device according to the first embodiment as viewed from a right side of FIG. 1.

FIG. 6 is a perspective view of the disc brake device according to the first embodiment as viewed from the axially outer side and the radially outer side.

FIG. 7 is a perspective view of the disc brake device according to the first embodiment as viewed from the axially inner side and the radially outer side.

FIG. 8 is a perspective view of the disc brake device according to the first embodiment as viewed from the axially outer side and the radially inner side.

FIG. 9 is a perspective view of the disc brake device according to the first embodiment as viewed from the axially inner side and the radially inner side.

FIG. 10 is a perspective view as viewed from the axially outer side and the radially outer side with a caliper body removed from the disc brake device according to the first embodiment.

FIG. 11 is a perspective view as viewed from the axially inner side and the radially outer side with the caliper body removed from the disc brake device according to the first embodiment.

FIG. 12 is a perspective view as viewed from the axially outer side and the radially inner side with the caliper body removed from the disc brake device according to the first embodiment.

FIG. 13 is a perspective view as viewed from the axially inner side and the radially inner side with the caliper body removed from the disc brake device according to the first embodiment.

FIG. 14 is a view as viewed from the axially outer side with an outer body portion of the caliper body removed from the disc brake device according to the first embodiment.

FIG. 15 is a view as viewed from the axially inner side with the outer body portion of the caliper body removed from the disc brake device according to the first embodiment.

FIG. 16 is a view as viewed from the axially inner side with the outer body portion of the caliper body and an outer pad removed from the disc brake device according to the first embodiment.

FIG. 17 is a view as viewed from the axially outer side with a support and a pad clip removed from the disc brake device according to the first embodiment.

FIG. 18 is a view as viewed from a right side of FIG. 1 with the support and the pad clip removed from the disc brake device according to the first embodiment.

FIG. 19 is a perspective view as viewed from the axially outer side and the radially outer side with the support and the pad clip removed from the disc brake device according to the first embodiment.

FIG. 20 is a partial perspective view of an assembled state of the inner pad and the outer pad to the support as viewed from the axially inner side and the radially outer side, regarding the first embodiment.

FIG. 21 is a view of an assembled state of the return spring and pad clips disposed on the axially outer side and a rotation-out side to the support, as viewed from the axially inner side, regarding the first embodiment.

FIG. 22 is a view as viewed from a circumferentially inner side with the pad clips disposed on the axially outer side and the rotation-out side removed from the disc brake device according to the first embodiment.

FIG. 23 is a view as viewed from a circumferentially outer side with the pad clips disposed on the axially outer side and the rotation-out side removed from the disc brake device according to the first embodiment.

FIG. 24 is a view as viewed from the axially inner side with the pad clips disposed on the axially outer side and the rotation-out side removed from the disc brake device according to the first embodiment.

FIG. 25 is a view corresponding to FIG. 14, showing a second embodiment.

FIG. 26 is a view corresponding to FIG. 15, showing the second embodiment.

FIG. 27 is a perspective view as viewed from the axially outer side and the radially outer side with the outer body portion of the caliper body removed from a disc brake device according to the second embodiment.

FIG. 28 is a view corresponding to FIG. 14, showing a third embodiment.

FIG. 29 is a view corresponding to FIG. 15, showing the third embodiment.

FIG. 30 is a view corresponding to FIG. 27, showing the third embodiment.

FIG. 31 is a view corresponding to FIG. 14, showing a fourth embodiment.

FIG. 32 is a view corresponding to FIG. 15, showing the fourth embodiment.

FIG. 33 is a view corresponding to FIG. 27, showing the fourth embodiment.

FIG. 34 is a view corresponding to FIG. 14, showing a fifth embodiment.

FIG. 35 is a view corresponding to FIG. 15, showing the fifth embodiment.

FIG. 36 is a view corresponding to FIG. 27, showing the fifth embodiment.

FIG. 37 are views showing a fifth embodiment, in which (A) is a cross-sectional view taken along a line A-A of FIG. 34, and (B) is a cross-sectional view taken along a line B-B of FIG. 34.

FIG. 38 is a partial cross-sectional view showing a floating disc brake device having a structure in the related art.

### DESCRIPTION OF EMBODIMENTS

### First Embodiment

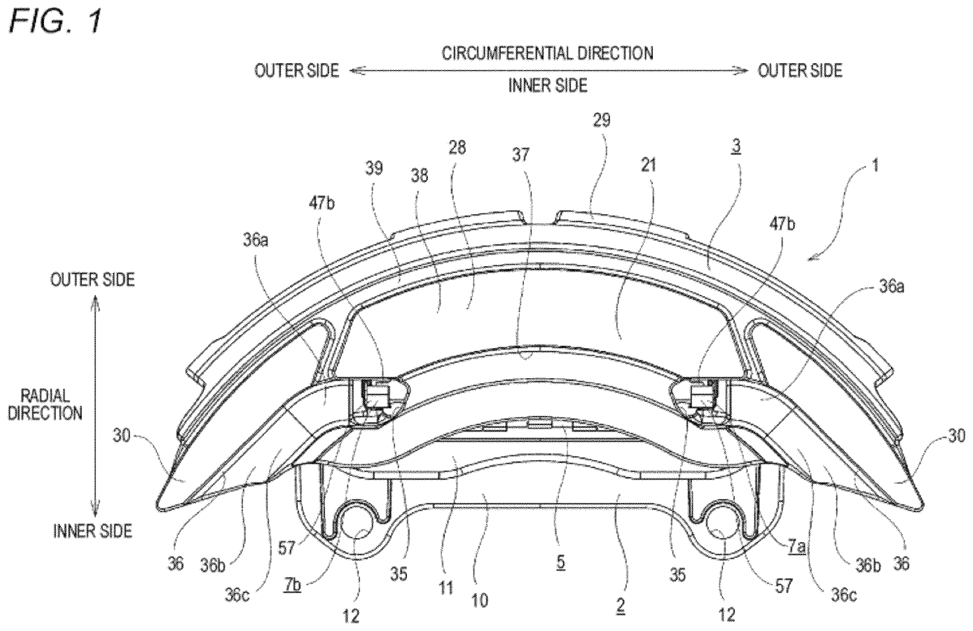

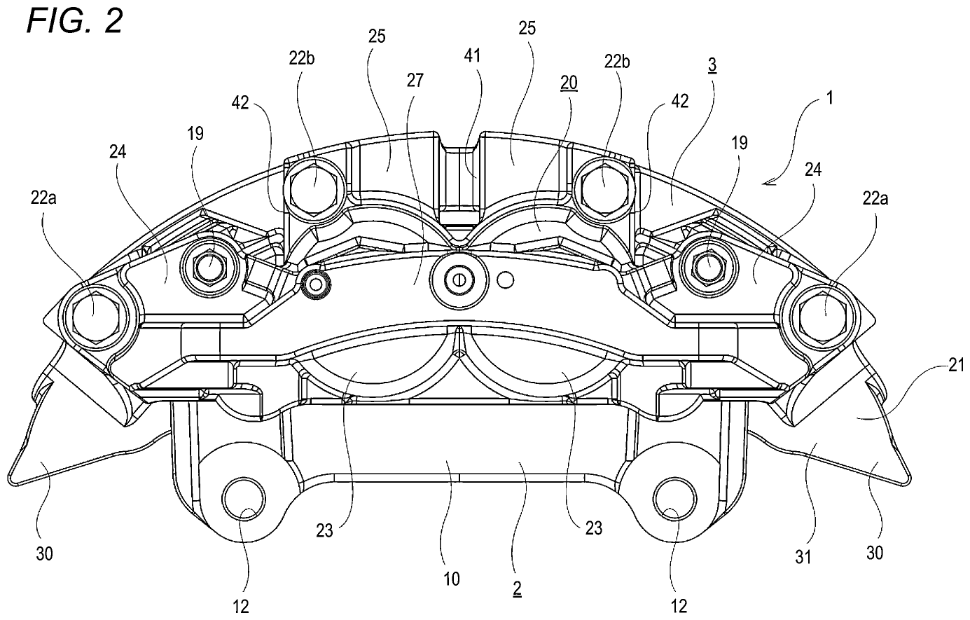

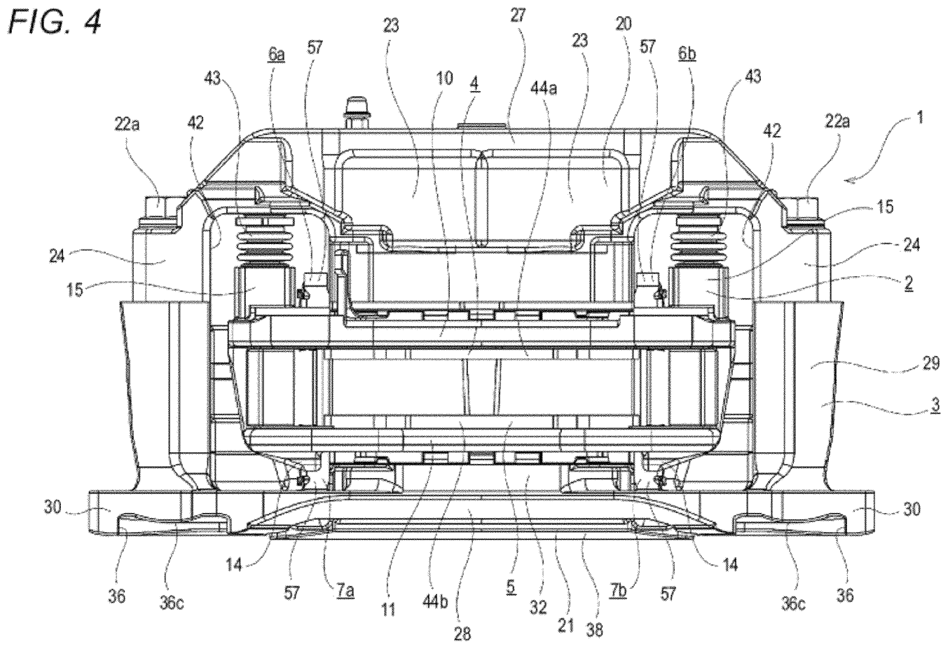

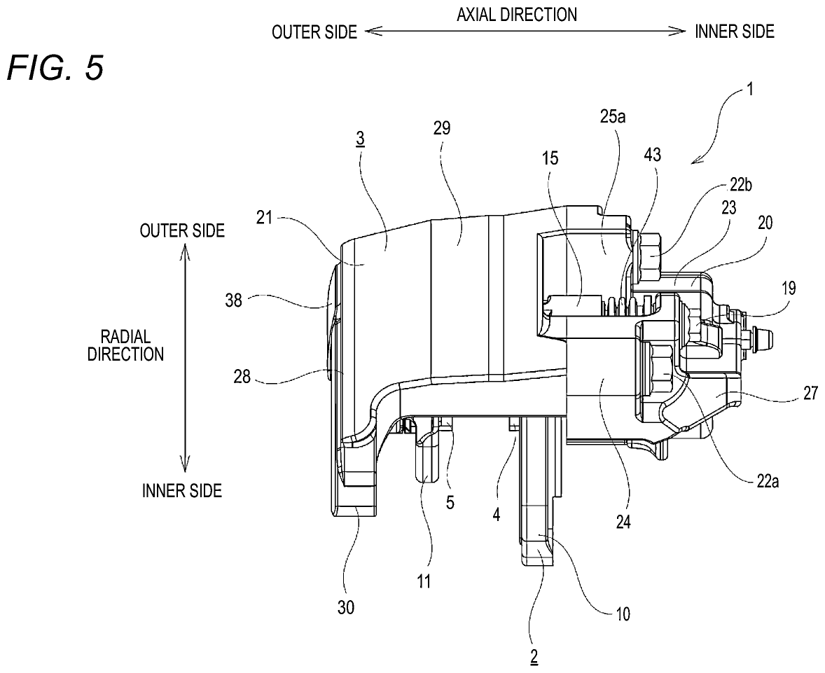

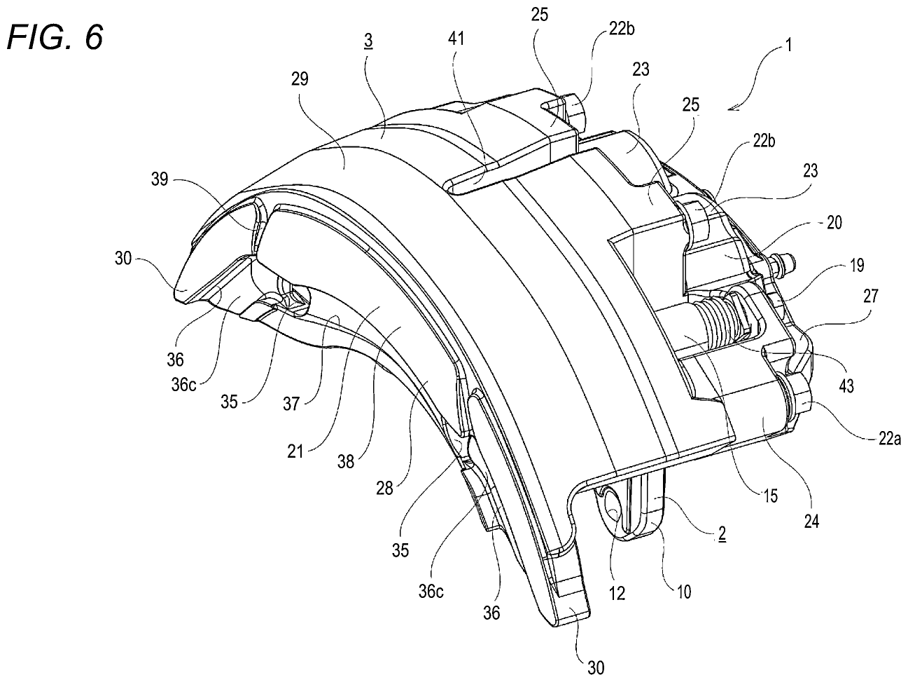

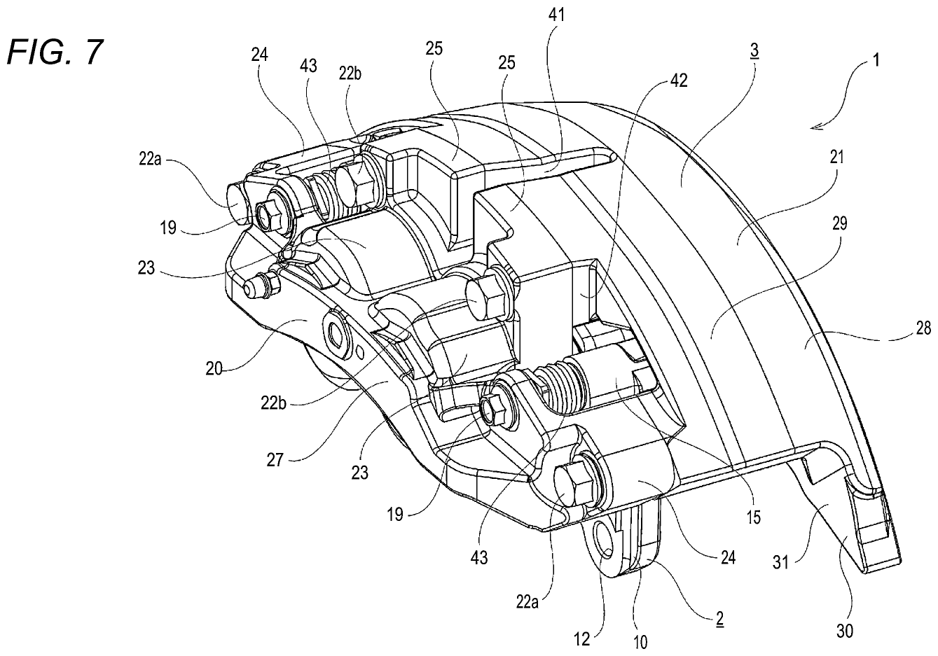

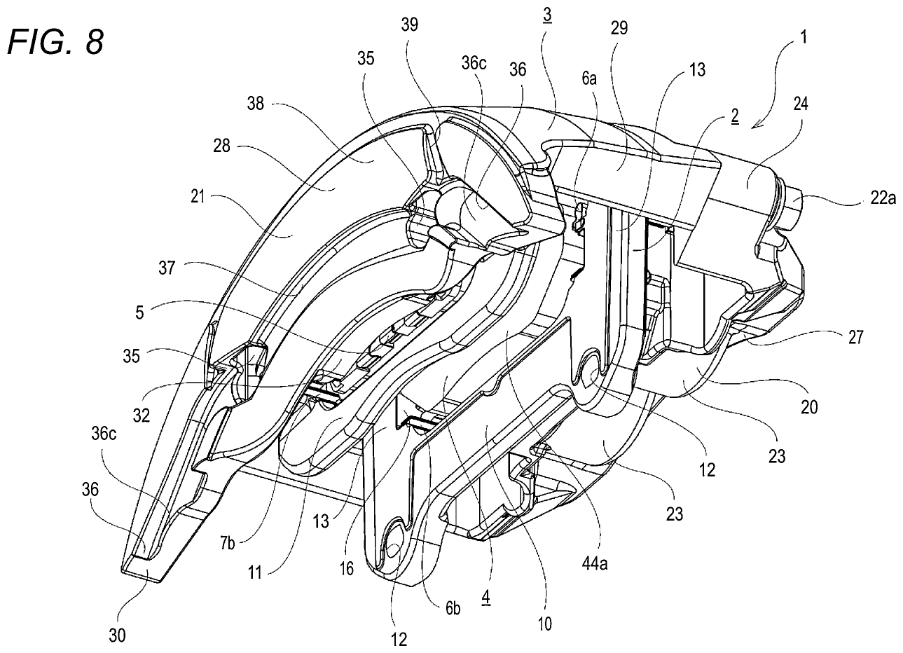

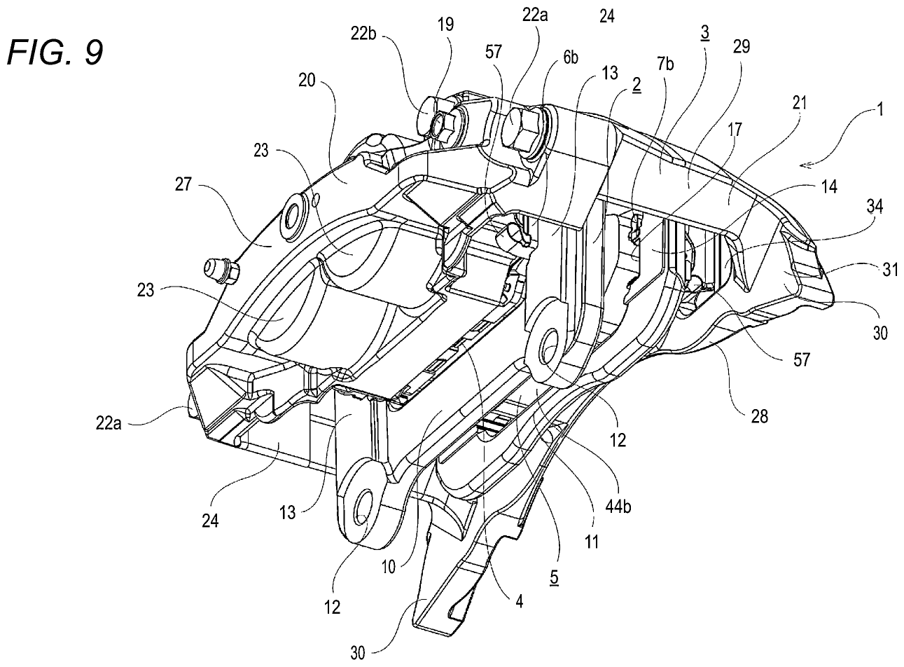

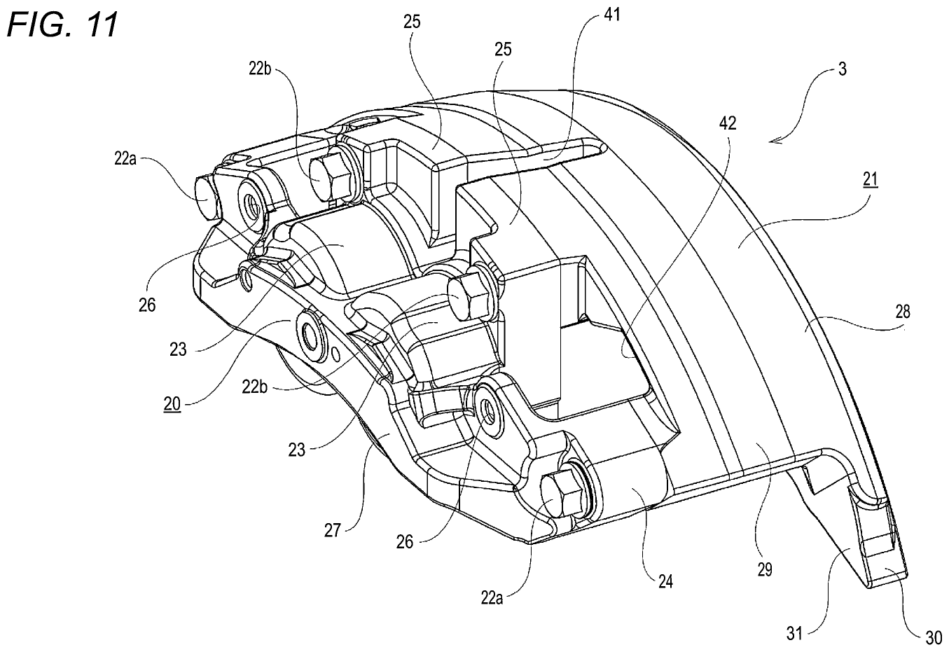

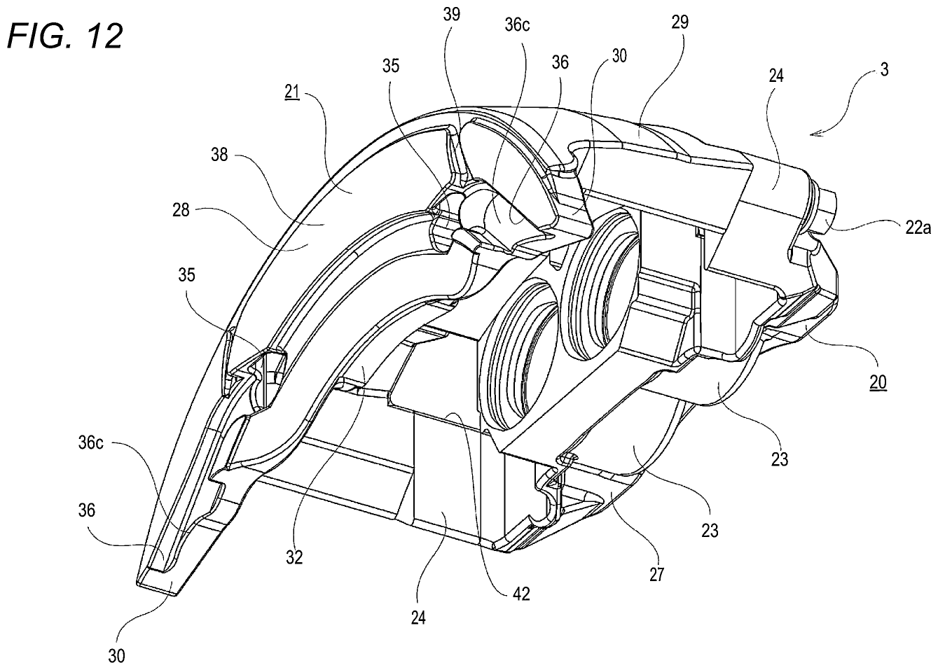

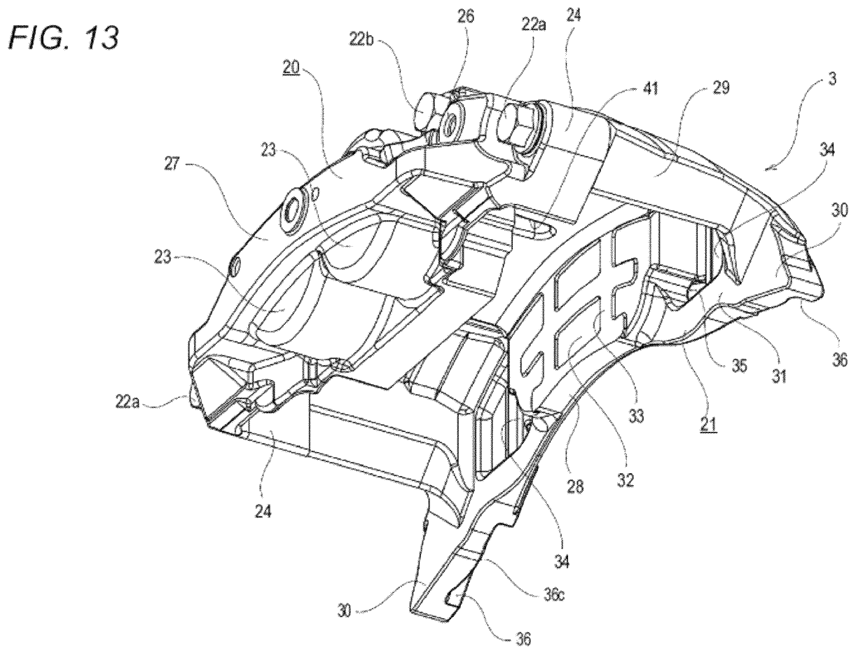

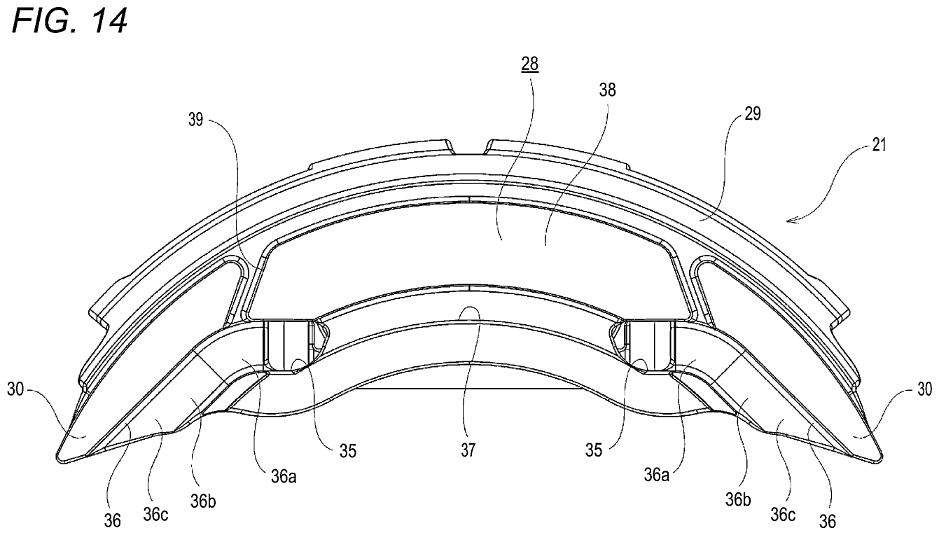

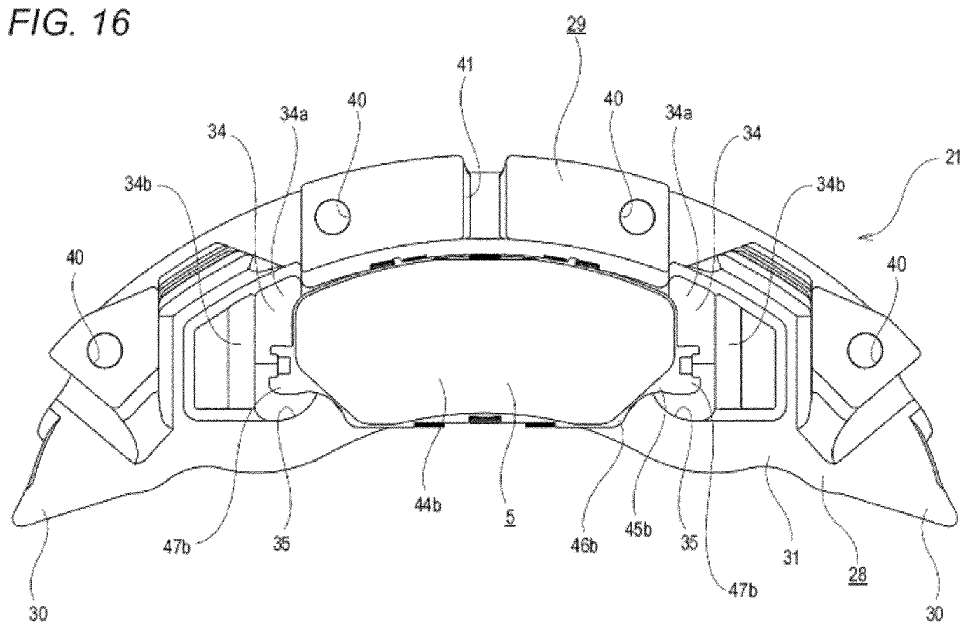

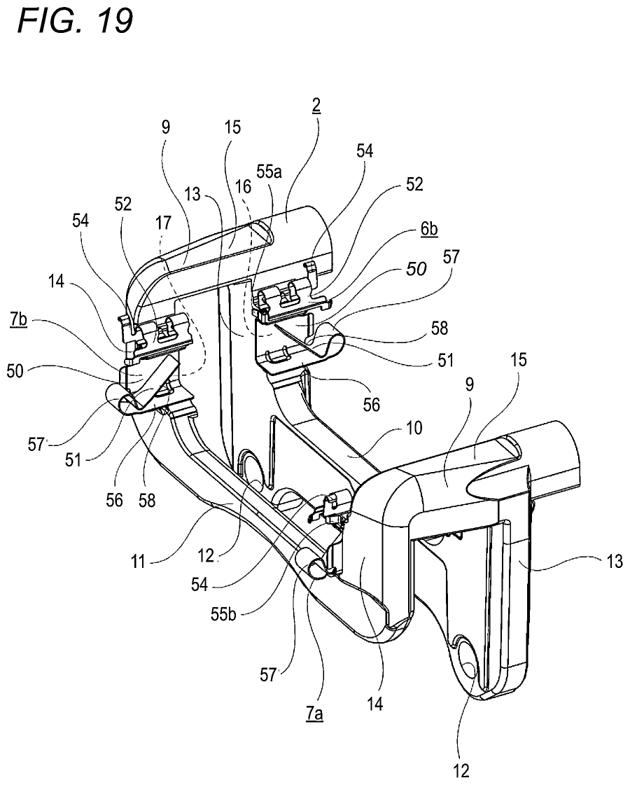

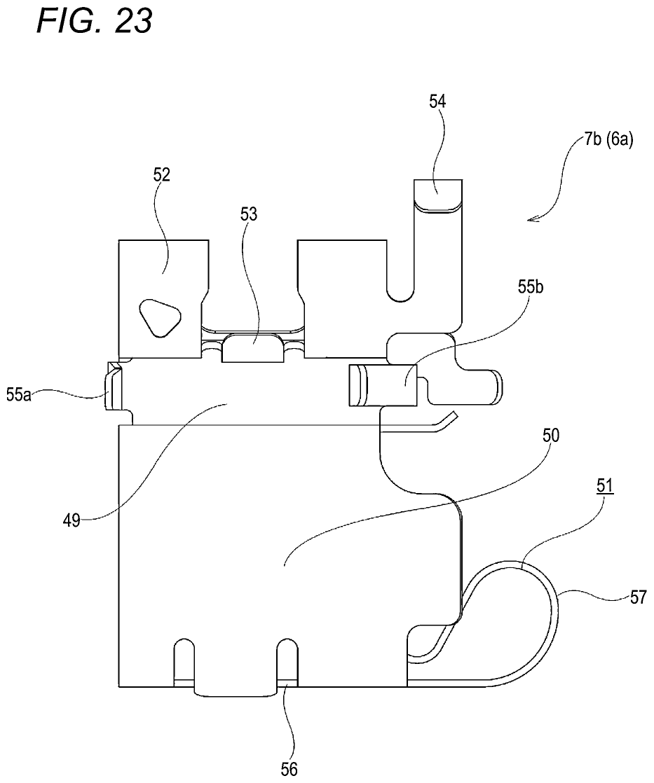

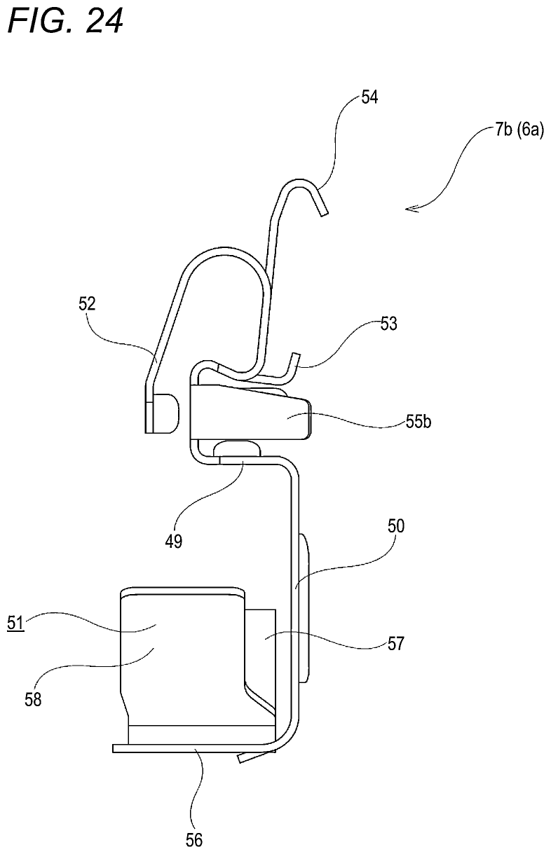

A first embodiment will be described with reference to FIGS. 1 to 24.

### [Description of Structure of Disc Brake Device]

A disc brake device 1 according to the present embodiment is a floating disc brake device, and includes a support 2, a caliper body 3, an inner pad 4, an outer pad 5, and four pad clips 6a, 6b, 7a, and 7b.

### <Support>

The support 2 is a cast product made of an iron alloy such as cast iron, and is fixed to a vehicle body. The support 2 supports the caliper body 3 such that the caliper body 3 is movable in an axial direction, and supports each of the inner pad 4 and the outer pad 5 such that the inner pad 4 and the outer pad 5 are movable in the axial direction.

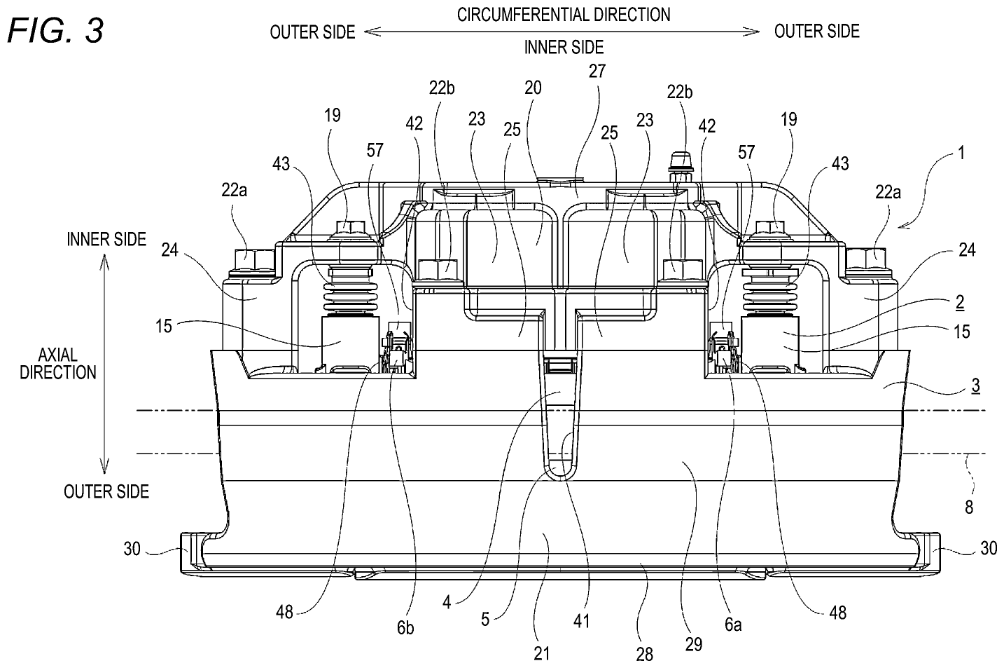

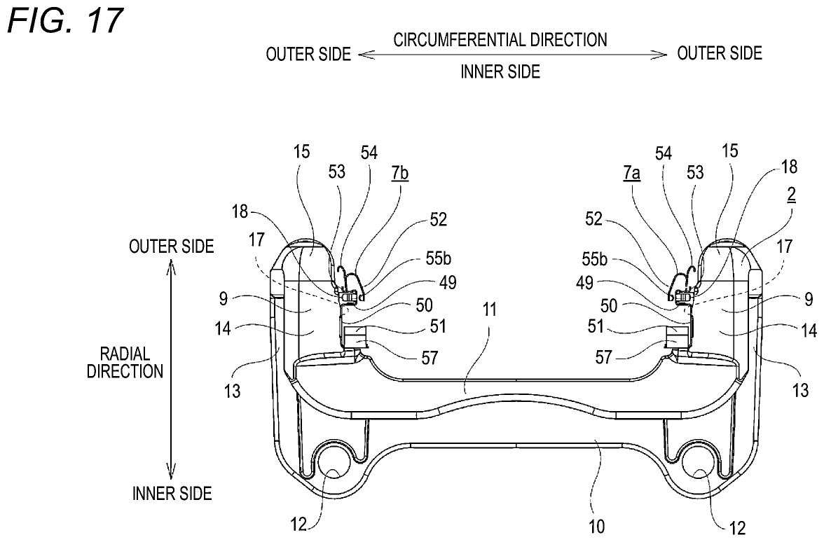

As shown in FIGS. 17 to 19, the support 2 includes a pair of guide portions 9 disposed on both circumferentially outer side ends, an inner side circumferential connection portion 10 disposed on an axially inner side of a rotor 8 (not shown in FIGS. 17 to 19, see FIG. 3) and extending in a circumferential direction, and an outer side circumferential connection portion 11 disposed on an axially outer side of the rotor 8 and extending in the circumferential direction. The support 2 is fixed to a suspension device constituting a vehicle body by using a pair of attachment holes 12 provided on both circumferential side ends of the inner side circumferential connection portion 10. In the case of implementing the present invention, the outer side circumferential connection portion 11 may be omitted from the support 2.

Each of the pair of guide portions 9 has an inverted U-shape as viewed in the circumferential direction, and is disposed to straddle the rotor 8 from the radially outer side. Each of the pair of guide portions 9 includes an inner guide portion 13 that supports the inner pad 4 such that the inner pad 4 is movable in the axial direction, an outer guide portion 14 that supports the outer pad 5 such that the outer pad 5 is movable in the axial direction, and a caliper guide portion 15 that connects a radially outer side end of each of the inner guide portion 13 and the outer guide portion 14 in the axial direction.

The inner guide portion 13 is disposed on the axially inner side of the rotor 8 and extends in the radial direction. A radially inner side end of the inner guide portion 13 is connected to a circumferentially outer side end of the inner side circumferential connection portion 10. The inner guide portion 13 includes an inner side guide recessed groove 16 recessed toward the circumferentially outer side on a radially inner side portion of a circumferentially inner side surface. The inner side guide recessed groove 16 is engageable with an ear portion 47a (to be described later) provided in the inner pad 4. The inner guide portion 13 includes a protruding portion (not shown) that protrudes toward the circumferentially inner side on a radially intermediate portion (a radially outer side of the inner side guide recessed groove 16) of the circumferentially inner side surface.

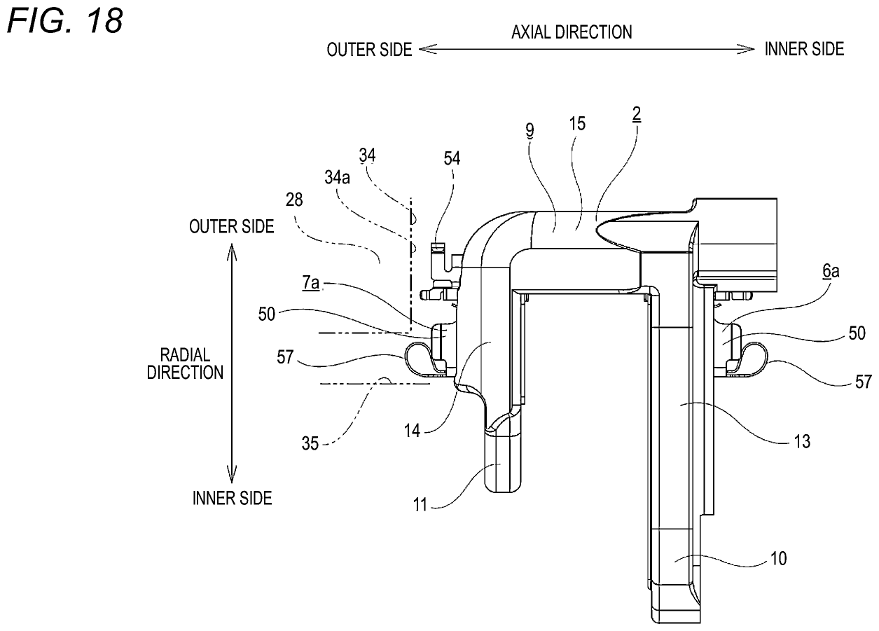

The outer guide portion 14 is disposed on the axially outer side of the rotor 8 and extends in the radial direction. A radially inner side end of the outer guide portion 14 is connected to a circumferentially outer side end of the outer side circumferential connection portion 11. The outer guide portion 14 includes an outer side guide recessed groove 17 recessed toward the circumferentially outer side on the radially inner side portion of the circumferentially inner side surface. The outer side guide recessed groove 17 is engageable with an ear portion 47b (to be described later) provided in the outer pad 5. The outer guide portion 14 includes a protruding portion 18 that protrudes toward the circumferentially inner side on a radially intermediate portion (a radially outer side of the outer side guide recessed groove 17) of the circumferentially inner side surface. As shown in FIG. 18, an axially outer side surface of the outer guide portion 14 protrudes to the axially outer side with respect to an axially outer side surface of the outer side circumferential connection portion 11.

The caliper guide portion 15 is disposed on a radially outer side of the rotor 8 and extends in the axial direction. A support hole 65 that extends in the axial direction is formed inside the caliper guide portion 15. The support hole 65 opens in an axially inner side surface of the caliper guide portion 15. A front half portion of a slide pin 19 (to be described later) is slidably inserted into the support hole 65. An axially inner side end of the caliper guide portion 15 is disposed to protrude to the axially inner side with respect to the inner guide portion 13.

### <Caliper Body>

The caliper body 3 is made of an aluminum alloy or an iron alloy, and has a boat shape. The caliper body 3 is supported to be movable in the axial direction with respect to the support 2 using the pair of slide pins 19.

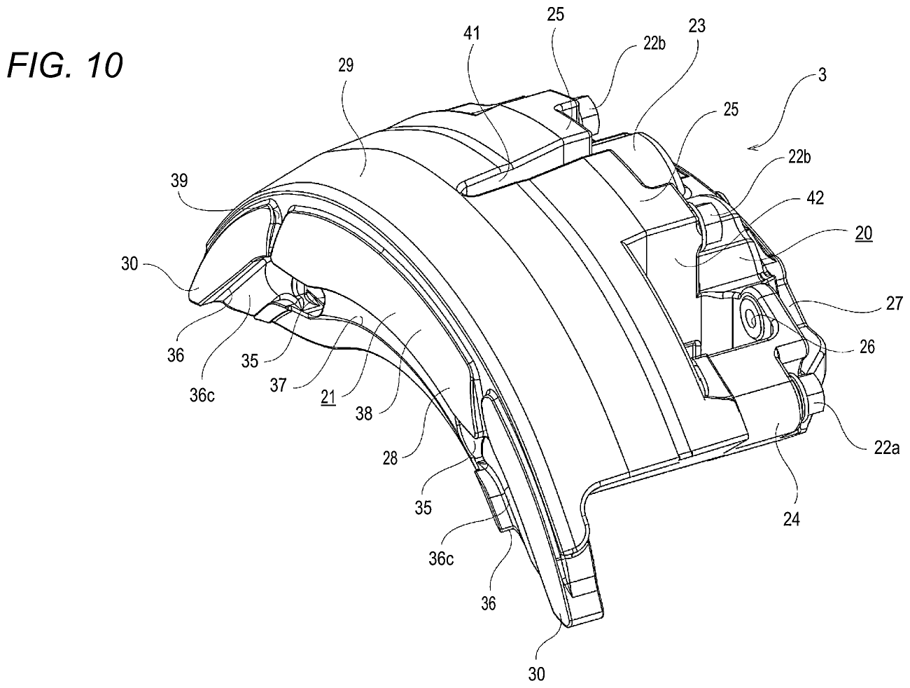

The caliper body 3 according to the present embodiment has a divided structure rather than an integral structure. That is, as shown in FIGS. 10 to 13, the caliper body 3 is configured by connecting an inner body portion 20 and an outer body portion 21 which are configured separately from each other in the axial direction by a plurality of (in the shown example, four in total) connection members 22a and 22b. When the present invention is implemented, the caliper body may have an integral structure.

### <<Inner Body Portion>>

The inner body portion 20 is disposed on the axially inner side of the rotor 8. The inner body portion 20 includes a pair of cylinders 23, a pair of circumferential arm portions 24, and a pair of radially protruding portions 25. When the present invention is implemented, the number of cylinders provided in the inner body portion is not particularly limited, and only one cylinder or three or more cylinders may be provided.

The pair of cylinders 23 are provided in a circumferentially intermediate portion of the inner body portion 20. The pair of cylinders 23 are disposed side by side in the circumferential direction in a state where central axes of the pair of cylinders 23 are parallel to a central axis of the rotor 8. The cylinder 23 has a substantially cylindrical shape and opens only to the axially outer side. A piston (not shown) is fitted into the cylinder 23 to be movable in the axial direction.

The pair of circumferential arm portions 24 are provided on both circumferentially outer side portions of the inner body portion 20. The pair of circumferential arm portions 24 are disposed on both circumferential outer sides of the pair of cylinders 23. Each circumferential arm portion 24 extends toward the circumferentially outer side from an outer circumferential surface of the cylinder 23.

The circumferential arm portion 24 includes an insertion hole through which the connection member 22a is inserted in the axial direction on a circumferentially outer side end (a distal end portion), and includes a fixing hole 26 for fixing a base end portion of the slide pin 19 in a circumferentially intermediate portion. The circumferentially outer side end of the circumferential arm portion 24 is offset to the axially outer side compared to a circumferentially inner side end and an intermediate portion of the circumferential arm portion 24. Therefore, the circumferential arm portion 24 has a substantially L shape as viewed in the radial direction. An axially outer side surface on the circumferentially outer side end of the circumferential arm portion 24 is a flat surface.

The pair of radially protruding portions 25 are disposed in the circumferentially intermediate portion of the inner body portion 20 in a state of being separated from each other in the circumferential direction. The pair of radially protruding portions 25 are disposed on the radially outer sides of the axially outer side portions of the pair of cylinders 23. Each of the radially protruding portions 25 is formed in a flat plate shape and extends toward the radially outer side from the outer circumferential surface of the cylinder 23. The radially protruding portion 25 includes an insertion hole through which the connection member 22b is inserted in the axial direction. An axially outer side surface of the radially protruding portion 25 is a flat surface, and is located on the same virtual plane as the axially outer side surface on the circumferentially outer side end of the circumferential arm portion 24

The inner body portion 20 includes a strip-shaped rib 27 that extends in the circumferential direction on an axially inner side surface of the inner body portion 20. The strip-shaped rib 27 covers bottom portions of the pair of cylinders 23 so as to cross the bottom portions in the circumferential direction. A circumferentially intermediate portion of the strip-shaped rib 27 is curved in a substantially arc shape such that the radially outer side is convex as viewed in the axial direction. The both circumferentially outer side ends of the strip-shaped rib 27 are disposed on the both circumferentially outer side portions of the inner body portion 20, and are disposed in the vicinity of an axially inner side end of the connection member 22a disposed on the circumferentially outer side.

### <<Outer Body Portion>>

The outer body portion 21 includes a substantially arcuate axial cover portion 28 disposed on an axially outer side of the outer pad 5, and a partially cylindrical radial cover portion 29 disposed on the radially outer side of the rotor 8. The outer body portion 21 has a substantially L-shaped cross-sectional shape in relation to a virtual plane including the central axis of the rotor 8. The axial cover portion 28 and the radial cover portion 29 are integrally formed.

The axial cover portion 28 is formed in a substantially arcuate flat plate shape, and directly presses the outer pad 5 in the axial direction during braking. The axial cover portion 28 is a portion that is visible from the outside in a state where the disc brake device 1 is attached to the vehicle body, and a design surface is formed by an axially outer side surface.

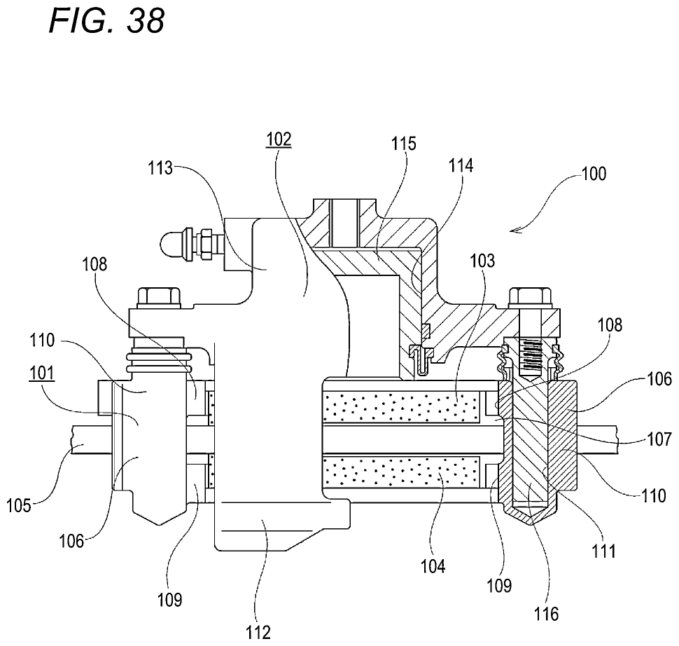

In the present embodiment, a circumferential dimension of the axial cover portion 28 is sufficiently larger than that of the outer body portion 112 having a structure in the related art shown in FIG. 38. Specifically, the circumferential dimension of the axial cover portion 28 is made larger than a circumferential dimension of the support 2, and both circumferentially outer side portions of the axial cover portion 28 protrude to a circumferentially outer side with respect to the pair of guide portions 9. The axial cover portion 28 covers the pair of guide portions 9 from the axially outer side. In other words, the pair of guide portions 9 is not visible from the outside. In the case of the present embodiment, by setting the circumferential dimension of the axial cover portion 28 to be larger than the circumferential dimension of the support 2 as described above, a large design surface constituted by the axially outer side surface of the axial cover portion 28 is secured.

In the present embodiment, the circumferential dimension of the axial cover portion 28 is larger than a circumferential dimension of each of the radial cover portion 29 and the inner body portion 20. For this purpose, a substantially triangular plate-shaped blade portion 30 that protrudes to the circumferentially outer side with respect to the radial cover portion 29 and the inner body portion 20 is provided at both circumferentially outer side ends of the axial cover portion 28.

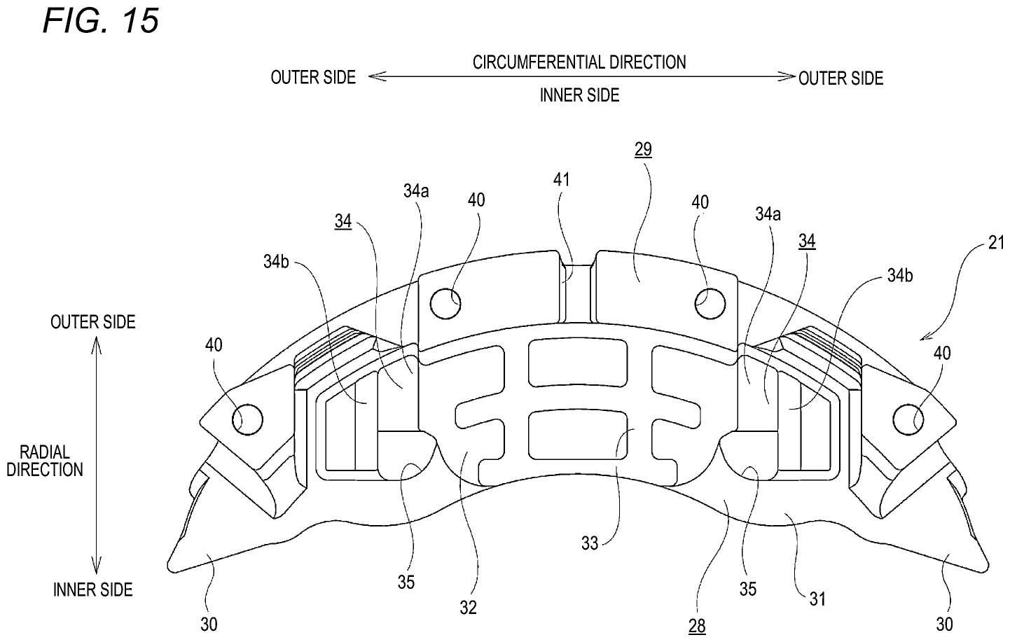

As shown in FIG. 15, the axial cover portion 28 includes a reference surface 31 having a flat surface shape on an axially inner side surface of the axial cover portion 28. The axial cover portion 28 includes a protruding portion 32 that protrudes to the axially inner side with respect to the reference surface 31 in a circumferentially intermediate portion of the axially inner side surface of the axial cover portion 28. The protruding portion 32 is provided on substantially the entire portion of the axially inner side surface of the axial cover portion 28 that faces a base plate portion 46b (to be described later) constituting the outer pad 5 in the axial direction. Therefore, the protruding portion 32 has a shape that substantially matches the base plate portion 46b of the outer pad 5. An axially inner side surface (a distal end surface) of the protruding portion 32 is provided with a contact convex portion 33 that rises to the axially inner side. In the shown example, the contact convex portion 33 has a substantially lattice shape. The contact convex portion 33 comes into contact with an axially outer side surface (a back surface) of the base plate portion 46b of the outer pad 5 during braking.

The axial cover portion 28 includes a pair of relief recessed portions 34 recessed toward the axially outer side from the reference surface 31 on both circumferentially outer side portions of the protruding portion 32 of the axially inner side surface. The relief recessed portions 34 are provided in portions of the axially inner side surface of the axial cover portion 28 that face a pair of outer guide portions 14 constituting the support 2 and the vicinity of the outer guide portions 14 in the axial direction. Specifically, the relief recessed portions 34 are provided in the portions that face the outer guide portion 14 in the axial direction, and in portions that face portions located in the vicinity of circumferentially inner sides of the outer guide portions 14 in the axial direction.

Each of the relief recessed portions 34 includes a deep recessed portion 34a on a circumferentially inner side portion, and includes, on a circumferentially outer side of the deep recessed portion 34a, a shallow recessed portion 34b having a lower axial depth than that in the deep recessed portion 34a.

When wear of the inner pad 4 and the outer pad 5 progresses and the caliper body 3 moves to the axially inner side with respect to the support 2, an axially outer side portion of the outer guide portion 14 and axially outer side portions of pad clips 7a and 7b attached to circumferentially inner side surfaces of the outer guide portion 14 can be respectively inserted into the relief recessed portion 34. Specifically, the axially outer side portion of the outer guide portion 14 can be inserted into the shallow recessed portion 34b, and the axially outer side portions of the pad clip 7a and 7b can be inserted into the deep recessed portion 34a. With such a configuration, interference between the pair of outer guide portion 14 and the pad clips 7a and 7b, and the outer body portion 21 is suppressed.

In particular, the pad clips 7a and 7b used in the present embodiment have a configuration in which the curl portion 57 protrudes more to the axially outer side than the other portions of the pad clips 7a and 7b as described later. Therefore, in the present embodiment, in order to suppress interference between a bottom surface of the deep recessed portion 34a and the curl portion 57, an axial depth of the entire deep recessed portion 34a is not increased, and through holes 35 into which only the curl portion 57 can be inserted are formed in the axial cover portion 28. Accordingly, as compared with a case where the axial depth of the entire deep recessed portion 34a is increased, a decrease in the rigidity of the outer body portion 21 is suppressed.

In the present embodiment, the through holes 35 that open only in the axial direction are formed in portions of the axial cover portion 28 that face the vicinity of each of the pair of outer guide portions 14 constituting the support 2 in the axial direction. Specifically, the through holes 35 open only in the axially outer side surface and the axially inner side surface of the axial cover portion 28, and do not open in other portions (for example, the radial cover portion 29). In addition, the through holes 35 are formed in portions of the axial cover portion 28 that are located in the vicinity of the circumferentially inner side of the outer guide portion 14 and that face an internal space of the outer side guide recessed groove 17 in the axial direction. In the present embodiment, two through holes 35 are formed for the axial cover portion 28.

An opening portion on an axially inner side of each through hole 35 is located at a radially inner side portion of the bottom surface of the deep recessed portion 34a. The through hole 35 can be formed by, for example, cutting (drilling) using a cutting tool such as a drill.

As shown in FIG. 18, during braking, an axially outer side portion of a curl portion 57, which is a portion of the pad clips 7a and 7b that protrudes most to the axially outer side, is inserted into the through hole 35. The through hole 35 has such a shape and size that the curl portion 57 can be inserted substantially without a gap. Therefore, a decrease in rigidity of the caliper body 3 due to the formation of the through hole 35 can be suppressed.

A central axis of the through hole 35 is disposed parallel to the central axis of the rotor 8. A cross-sectional shape of the through hole 35 is constant in the axial direction. In the shown embodiment, the through hole 35 has a substantially pentagonal or substantially trapezoidal cross-sectional shape (an opening shape). When the present invention is implemented, a central axis of a through hole may be inclined with respect to a central axis of a rotor, and a cross-sectional shape (an opening shape) of the through hole may be another shape such as a circle, an ellipse, or a quadrangle.

The through hole 35 has a circumferential dimension slightly larger than a radial dimension. Therefore, by changing a circumferential dimension of the outer pad 5 to be used, even when a circumferential interval between the pair of pad clips 7a and 7b (the curl portion 57) is changed, the outer pad 5 can be used as it is without changing a shape of the through hole 35.

When the present invention is implemented, in a case where there are a plurality of portions of the pad clip that protrude more to the axially outer side than the other portions, it is possible to form only one through hole into which the portions can be collectively inserted, or to form a plurality of through holes into which the portions can be inserted one by one. In addition, even when the inner pad and the outer pad are fully worn, if interference between an axially outer side surface of an outer guide portion and an axially inner side surface of an axial cover portion can be suppressed, a shallow recessed portion can be omitted from a relief recessed portion. In addition, in a case where interference between a portion of the pad clip other than the portion that largely protrudes to the axially outer side, such as the curl portion, and the axially inner side surface of the axial cover portion can be suppressed, it is also possible to omit the deep recessed portion from the relief recessed portion, that is, omit the relief recessed portion itself, and form only the through hole.

The axial cover portion 28 includes first recessed grooves 36 connected to the opening portion on the axially outer side of the through hole 35 on the axially outer side surface. Each of the first recessed grooves 36 extends in the circumferential direction, and a circumferentially inner side end is connected to the opening portion on the axially outer side of the through hole 35. Therefore, the axial cover portion 28 includes two first recessed grooves 36. Each of the first recessed grooves 36 corresponds to a recessed groove described in the claims.

A width dimension of the first recessed groove 36 is substantially constant over an entire length of the first recessed groove 36, and is substantially the same as a radial dimension of the opening portion on the axially outer side of the through hole 35. In the present embodiment, the first recessed groove 36 is provided to be connected to the opening portion on the axially outer side of the through hole 35, and the width dimension of the first recessed groove 36 is substantially the same as the radial dimension of the opening portion on the axially outer side of the through hole 35. Therefore, the through hole 35 and the first recessed groove 36 can be smoothly continued, and the opening portion on the axially outer side of the through hole 35 can be made inconspicuous from the outside. In addition, the designability can be improved by taking in the opening portion on the axially outer side of the through hole 35 as a portion of the design of the design surface.

Each of the first recessed grooves 36 includes a curved portion 36a curved in a substantially arc shape such that a radially outer side of the first recessed groove 36 is convex on the circumferentially inner side portion, and a linear portion 36b in a linear shape on the circumferentially outer side portion. The linear portion 36b extends in a direction toward the radially inner side, toward the circumferentially outer side so as to follow a contour shape of an outer peripheral edge of the axial cover portion 28. Further, a circumferentially outer side end of the first recessed groove 36 (the linear portion 36b) opens to a substantially linear radially inner side surface corresponding to a string of the axial cover portion 28.

A bottom surface 36c of the first recessed groove 36 is not a flat surface but a convex curved surface curved in an arc shape. Specifically, the bottom surface 36c of the first recessed groove 36 is a convex curved surface that is curved in an arc shape such that a width direction intermediate portion protrudes to an axially outer side with respect to both width direction side portions.

The axial cover portion 28 includes a second recessed groove 37 connecting the opening portions on the axially outer side of the through hole 35 on the axially outer side surface. The second recessed groove 37 extends in the circumferential direction and is curved such that the radially outer side is convex. A width dimension of the second recessed groove 37 is substantially constant over an entire length of the second recessed groove 37, and is substantially the same as the radial dimension of the opening portion on the axially outer side of the through hole 35. Therefore, a pair of first recessed grooves 36 disposed on both circumferential outer sides are smoothly continuous in the circumferential direction via a pair of through holes 35 and the second recessed groove 37.

The axial cover portion 28 includes an annular sector-shaped display portion 38 usable for displaying a logo or the like on the circumferentially intermediate portion of the axially outer side surface. The display portion 38 has a flat surface shape, and is disposed on a radially outer side of the pair of through holes 35 and the second recessed groove 37. In the present embodiment, since the circumferential dimension of the axial cover portion 28 is larger than the circumferential dimension of the support 2, a circumferential dimension of the display portion 38 can be sufficiently increased. Since both circumferential outer sides and a radially outer side of the display portion 38 are surrounded by a groove portion 39, the display portion 38 is visually recognized as being lifted to the axially outer side.

The radial cover portion 29 has a partially cylindrical shape and extends toward an axially inner side from an outer peripheral edge portion of the axial cover portion 28. The radial cover portion 29 covers the pair of guide portions 9 constituting the support 2, a portion of the rotor 8 in the circumferential direction, and the inner pad 4 and the outer pad 5 from the radially outer side. A circumferential dimension of the radial cover portion 29 is the same as a circumferential dimension of the inner body portion 20.

The radial cover portion 29 includes attachment holes (screw holes) 40 for fixing distal end portions of the connection members 22a and 22b at a plurality of positions (four positions in the shown embodiment) in the circumferential direction. The plurality of attachment holes 40 are disposed at the same pitch in the circumferential direction with a plurality of insertion holes provided in the inner body portion 20. The attachment hole 40 opens in an axially inner side surface of the radial cover portion 29.

The radial cover portion 29 includes a central window 41 that open on both radial sides on an axially inner side portion of a circumferential central portion. The central window 41 has an elongated slit shape in the axial direction. The central window 41 also opens to the axially inner side surface of the radial cover portion 29. The central window 41 can be used to visually check a wear state of the inner pad 4 and the outer pad 5.

The outer body portion 21 including the axial cover portion 28 and the radial cover portion 29 is fixed to an axially outer side of the inner body portion 20 using the connection members 22a and 22b, which are bolts. Specifically, a distal end portion of the connection member 22a inserted through an insertion hole provided in the circumferential arm portion 24 of the inner body portion 20 in the axial direction is screwed into the attachment hole 40 provided in a circumferentially outer side portion of the radial cover portion 29 of the outer body portion 21, and a distal end portion of the connection member 22b inserted through an insertion hole provided in the radially protruding portion 25 of the inner body portion 20 in the axial direction is screwed into the attachment hole 40 provided in a circumferentially inner side portion of the radial cover portion 29 of the outer body portion 21. Accordingly, the outer body portion 21 is connected to the axially outer side of the inner body portion 20 using the connection members 22a and 22b.

In a state where the inner body portion 20 and the outer body portion 21 are connected to each other, a pair of opening portions 42 are formed between an axially outer side surface of the inner body portion 20 and an axially inner side surface of the outer body portion 21. The pair of opening portions 42 are separated from each other in the circumferential direction, and are disposed on both circumferential outer sides of the pair of radially protruding portions 25. Each of the opening portions 42 is formed in a substantially rectangular shape as viewed in the radial direction. In an assembled state of the disc brake device 1, an axially inner side portion of the caliper guide portion 15 constituting the support 2 is exposed from the opening portion 42.

The caliper body 3 is supported to be movable in the axial direction with respect to the support 2. For this purpose, the base end portion of the slide pin 19 is fixed to the fixing hole 26 provided in a circumferentially intermediate portion of the circumferential arm portion 24 constituting the inner body portion 20, and the front half portion of the slide pin 19 is inserted into the support hole 65 formed in the caliper guide portion 15 constituting the support 2 so as to be able to be relatively displaced (slide) in the axial direction. In addition, a portion of an outer circumferential surface of the slide pin 19 located between the support hole 65 and the fixing hole 26 is covered by a boot 43.

### <Inner Pad and Outer Pad>

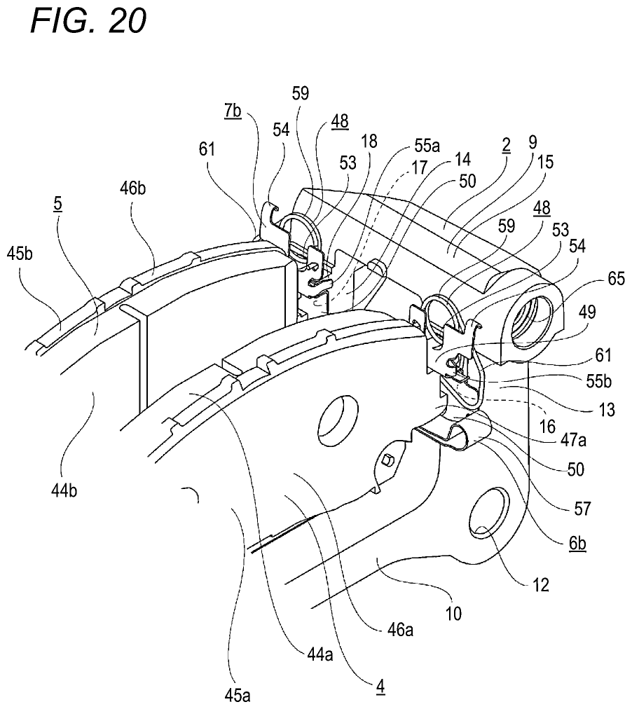

As shown in FIG. 20, the inner pad 4 includes a lining 44a and a back plate 45a, and is supported between a pair of inner guide portions 13 constituting the support 2 to be movable in the axial direction.

The back plate 45a includes a rectangular plate-shaped base plate portion 46a that supports a back surface (an axially inner side surface) of the lining 44a, and convex ear portions 47a that protrude from the base plate portion 46a toward both circumferential outer sides. The base plate portion 46a has a shape substantially matching the lining 44a.

In order to support the inner pad 4 such that the inner pad 4 is movable in the axial direction with respect to the pair of inner guide portions 13, the ear portions 47a constituting the inner pad 4 are engaged with the inner side guide recessed groove 16 provided in the inner guide portions 13 in a concave-convex manner.

The outer pad 5 includes a lining 44b and a back plate 45b, and is supported between a pair of outer guide portions 14 constituting the support 2 to be movable in the axial direction.

The back plate 45b includes a rectangular plate-shaped base plate portion 46b that supports the back surface of the lining 44b, and the convex ear portions 47b that protrude from the base plate portion 46b toward both circumferential outer sides. The base plate portion 46b has a shape substantially matching the lining 44b.

In order to support the outer pad 5 such that the outer pad 5 is movable in the axial direction with respect to the pair of outer guide portions 14, the ear portions 47b constituting the outer pad 5 are engaged with the outer side guide recessed groove 17 provided in the outer guide portions 14 in a concave-convex manner.

### <Pad Clip>

The pad clips 6a and 6b are interposed between both circumferential outer surfaces of the back plate 45a constituting the inner pad 4 and circumferentially inner side surfaces of the pair of inner guide portions 13. In addition, the pad clips 7a and 7b are interposed between both circumferential outer surfaces of the back plate 45b constituting the outer pad 5 and circumferentially inner side surfaces of the pair of outer guide portions 14. Accordingly, smooth axial movement of the inner pad 4 and the outer pad 5 is made possible. The pad clips 7a and 7b disposed on the axially outer side correspond to a pad clips described in the claims.

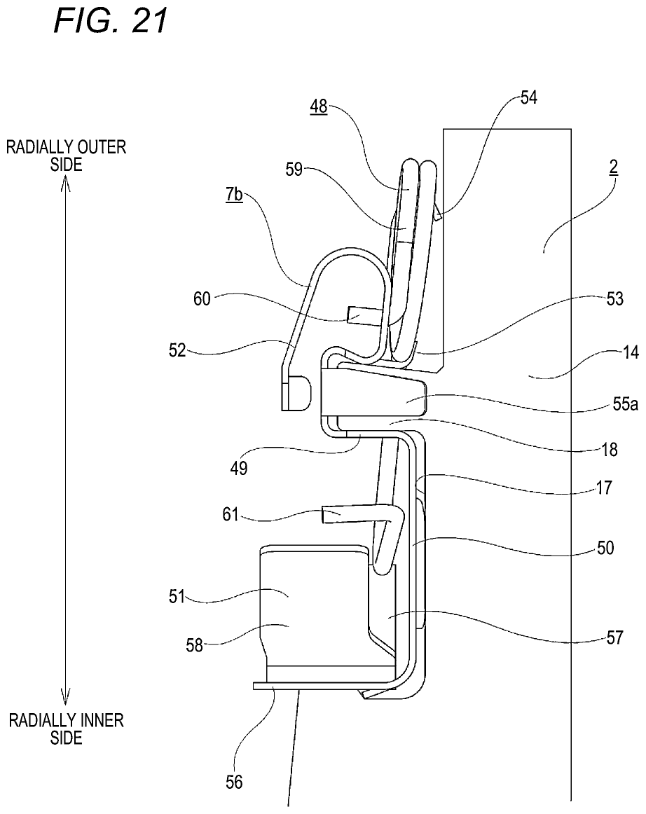

As shown in FIGS. 20 and 21, each of the pad clips 6a, 6b, 7a, and 7b is attached with a return spring 48 that urges the inner pad 4 and the outer pad 5 in a direction away from the rotor 8 when the braking force is released.

Among the four pad clips 6a, 6b, 7a, and 7b, the pair of pad clips 6a and 7a disposed on the rotation-in side (a right side in FIG. 17) and the pair of pad clips 6b and 7b disposed on the rotation-out side (a left side in FIG. 17) have symmetrical shapes in the axial direction. In addition, the pair of pad clips 6a and 6b disposed to face each other in the circumferential direction and the pair of pad clips 7a and 7b disposed to face each other in the circumferential direction have symmetrical shapes in the circumferential direction. Therefore, the detailed description of the pad clips 6a, 6b, 7a, and 7b is performed on only the pad clip 7b disposed on the axially outer side and the rotation-out side, and detailed description of the other pad clips 6a, 6b, and 7a is omitted.

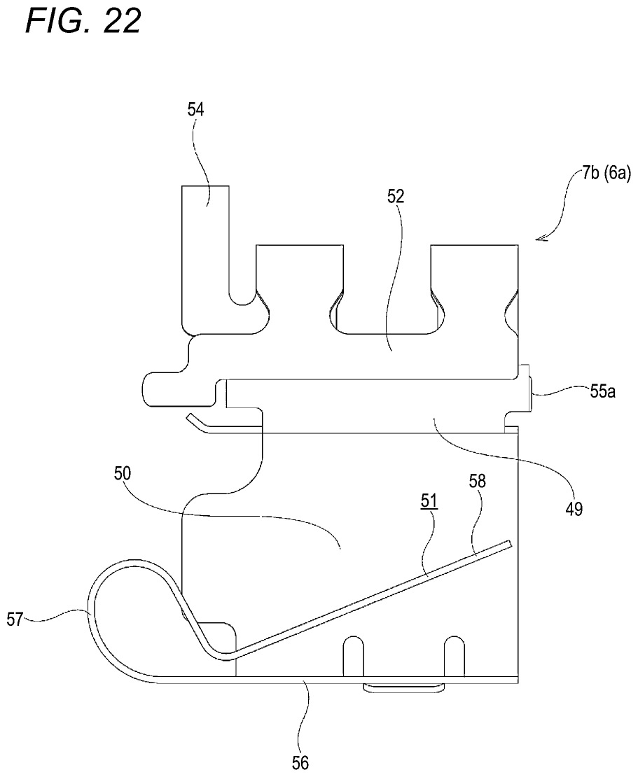

As shown in FIGS. 22 to 24, the pad clip 7b is formed by pressing a metal plate having elasticity and corrosion resistance, such as a stainless steel plate, and includes a clamping portion 49, a guide plate portion 50, a radial pressing portion 51, a circumferential pressing portion 52, a spring holding portion 53, and a restraining portion 54.

The clamping portion 49 is formed in a substantially rectangular U-shape in cross section, and is provided on a radially intermediate portion of the pad clip 7b. The clamping portion 49 elastically clamps the protruding portion 18 provided on the circumferentially inner side surface of the outer guide portion 14 from both radial sides to position the pad clip 7b in the radial direction. A pair of claw pieces 55a and 55b bent toward the circumferentially outer side are provided on both axial side ends of the clamping portion 49. The pair of claw pieces 55a and 55b elastically clamp the protruding portion 18 from both axial sides to position the pad clip 7b in the axial direction.

The guide plate portion 50 is formed in a flat plate shape, and is provided on a radially inner side portion of the pad clip 7b. The guide plate portion 50 is disposed along a bottom surface (a circumferentially inner side surface) of the outer side guide recessed groove 17. In addition, the guide plate portion 50 is disposed (clamped) between the bottom surface of the outer side guide recessed groove 17 and a distal end surface (a circumferentially outer side surface) of the ear portion 47b of the outer pad 5.

The radial pressing portion 51 is formed in a horizontal V shape, and is provided on a radially inner side end of the pad clip 7b. The radial pressing portion 51 includes a flat plate-shaped pressing base plate portion 56 that is bent at a substantially right angle from a radially inner side end of the guide plate portion 50 toward a circumferentially inner side, the substantially cylindrical curl portion 57 that is folded back at 180 degrees from an axially outer side end of the pressing base plate portion 56 toward a radially outer side and an axially inner side (a rotor 8 side), and a flat plate-shaped pressing body portion 58 that extends in a direction toward the radially outer side, from the curl portion 57 toward the axially inner side, in a free state.

The pressing body portion 58 is disposed on a radially inner side of the ear portion 47b when the ear portions 47b constituting the outer pad 5 are engaged with the outer side guide recessed groove 17 in a concave-convex manner. Based on the bending deformation of the curl portion 57, the ear portion 47b is pressed toward the radially outer side.

The circumferential pressing portion 52 is formed in an inverted U-shape, and is provided on a radially outer side portion of the pad clip 7b. The circumferential pressing portion 52 is bent and deformed to elastically press a circumferentially outer side surface of a radially outer side portion of the back plate 45b constituting the outer pad 5 (a radially outer side portion of the ear portion 47b) toward the circumferentially inner side (the rotation-out side).

The spring holding portion 53 is formed in a tongue shape, and is provided on the radially outer side portion of the pad clip 7b. The spring holding portion 53 is provided to extend to the circumferentially outer side from the clamping portion 49, and has a function of holding the return spring 48.

The restraining portion 54 is formed in an inverted J shape, and is provided in a radially outer side end of the pad clip 7b. The restraining portion 54 is provided in a state of being continuous with the circumferential pressing portion 52, and is provided to allow the return spring 48 to be attached to the pad clip 7b (an assembly of the pad clip 7b and the return spring 48 can be configured) in a state before the outer pad 5 is assembled, and an elastic force (a returning force) of the return spring 48 is supported to restrain the return spring 48.

In a state where the pad clip 7b as described above is attached to the circumferentially inner side surface of the outer guide portion 14, an axially outer side portion (an axially outer side portion of the guide plate portion 50, the curl portion 57, and the restraining portion 54) of the pad clip 7b is disposed to protrude to the axially outer side from the outer guide portion 14. In particular, the curl portion 57 protrudes more to the axially outer side than the other portion of the pad clip 7b, and is disposed to protrude most to the axially outer side from the outer guide portion 14.

Therefore, in the present embodiment, when wear of the inner pad 4 and the outer pad 5 progresses and the caliper body 3 moves to the axially inner side with respect to the support 2, the curl portion 57 constituting the pad clip 7b easily interferes with the axial cover portion 28 constituting the outer body portion 21 during braking. In the present embodiment, since the through holes 35 are provided in portions of the axial cover portion 28 that face the internal space of the outer side guide recessed groove 17 in the axial direction, and the curl portion 57 can be inserted into the through holes 35, interference between the curl portion 57 and the axial cover portion 28 can be suppressed.

### <Return Spring>

The return spring 48 is attached to the pad clip 7b (6a, 6b, 7a) according to the present embodiment.

The return spring 48 is a torsion coil spring formed by bending a wire material made of spring steel such as stainless steel or piano wire, and includes a coil portion 59, and a locking arm portion 60 and a spring arm portion 61 that are disposed on both axial sides with the coil portion 59 interposed therebetween.

The coil portion 59 is held by the spring holding portion 53 of the pad clip 7b in a state where a central axis of the coil portion 59 is directed in the circumferential direction.

The locking arm portion 60 is disposed on an axially inner side (the rotor 8 side) of the coil portion 59, and a distal end portion of the locking arm portion 60 is locked to the circumferential pressing portion 52.

The spring arm portion 61 is disposed on an axially outer side (an anti-rotor 8 side) of the coil portion 59, and is formed in a substantially rectangular U-shape as viewed in the circumferential direction. The distal end portion of the spring arm portion 61 abuts against an axially inner side surface of the ear portion 47b of the outer pad 5 and presses the outer pad 5 to the axially outer side (the anti-rotor 8 side).

In a state of being attached to the pad clip 7b, most of the return spring 48 except for a portion of the spring arm portion 61 is disposed on a circumferentially outer side (a rear surface side) of the pad clip 7b, and is configured so as not to largely protrude from the pad clip 7b not only in the circumferential direction but also in the axial direction and the radial direction.

### [Description of Operation of Disc Brake Device]

In order to perform braking by the disc brake device 1 according to the present embodiment, pressure oil is fed from a master cylinder to the cylinder 23 of the caliper body 3. Accordingly, a piston (not shown) is pushed toward the axially outer side. The inner pad 4 is pressed against the axially inner side surface of the rotor 8 by the piston, and the caliper body 3 is moved to the axially inner side with respect to the support 2. Accordingly, the contact convex portion 33 of the protruding portion 32 provided in the axial cover portion 28 constituting the caliper body 3 is pressed against a back surface of the back plate 45b constituting the outer pad 5. Thus, the outer pad 5 is pressed against an axially outer side surface of the rotor 8. As a result, the rotor 8 is strongly clamped by the inner pad 4 and the outer pad 5 from both axial sides to perform braking.

When the braking is released, the pressure oil is discharged from the cylinder 23 of the caliper body 3. Accordingly, the piston is pulled back (rolled back) to a back side (an axially inner side) of the cylinder 23 by an elastic restoring force of a piston seal (not shown) externally fitted to the piston, and a clearance between the inner pad 4 and the axially inner side surface of the rotor 8 is secured. As a result, the caliper body 3 slightly moves to the axially outer side with respect to the support 2, and a clearance between the outer pad 5 and the axially outer side surface of the rotor 8 is also secured.

According to the disc brake device 1 in the present embodiment as described above, even when a large design surface constituted by the axially outer side surface of the axial cover portion 28 is secured, interference between the outer guide portion 14 of the support 2 and the pad clips 7a and 7b attached to the outer guide portion 14, and the axial cover portion 28 of the caliper body 3 can be suppressed.

In the present embodiment, in order to ensure a large design surface formed by the axially outer side surface of the axial cover portion 28, the circumferential dimension of the axial cover portion 28 is made larger than the circumferential dimension of the support 2, and the pair of guide portions 9 is covered from the axially outer side by the axial cover portion 28. In addition, the pad clips 7a and 7b are attached to the circumferentially inner side surfaces of the pair of outer guide portions 14, and the curl portion 57 of the pad clips 7a and 7b is disposed to protrude more to the axially outer side than the outer guide portions 14. Therefore, when wear of the inner pad 4 and the outer pad 5 progresses and the caliper body 3 moves to the axially inner side with respect to the support 2, the curl portion 57 and the axial cover portion 28 easily interfere with each other during braking. Therefore, in the present embodiment, the curl portion 57 is inserted into the through hole 35 by forming the through hole 35 in a portion of the axial cover portion 28 that faces the internal space of the outer side guide recessed groove 17 in the axial direction. Accordingly, interference between the curl portion 57 and the axial cover portion 28 can be suppressed.

In addition, the through hole 35 opens only in the axially outer side surface and the axially inner side surface of the axial cover portion 28, and does not open in other portions (for example, the radial cover portion 29). Therefore, a decrease in rigidity of the caliper body 3 due to the formation of the through hole 35 can be suppressed. In addition, heat of an engagement portion between the ear portion 47b of the outer pad 5 and the outer side guide recessed groove 17 can be released through the through hole 35, and the engagement portion can also be cooled. Further, by forming the through hole 35, a weight of the caliper body 3 can be reduced.

In addition, since a shape and a size of the through hole 35 are regulated to a shape and a size in which the curl portion 57 of the pad clips 7a and 7b can be inserted substantially without a gap, it is possible to minimize a decrease in the rigidity of the caliper body 3 due to the formation of the through hole 35.

Furthermore, in the present embodiment, the relief recessed portions 34 are formed in portions of the axially inner side surface of the axial cover portion 28 that face the outer guide portion 14 and the vicinity of the outer guide portion 14 in the axial direction. Therefore, when the wear of the inner pad 4 and the outer pad 5 progresses and the caliper body 3 moves to the axially inner side with respect to the support 2, the axially outer side portion of the outer guide portion 14, the axially outer side portions of the pad clips 7a and 7b (the axially outer side portion of the guide plate portion 50 and the restraining portion 54), and an axially outer side portion of the return spring 48 (an axially outer side portion of the spring arm portion 61) can be inserted into the relief recessed portion 34. Therefore, interference between the axially outer side portion of the outer guide portion 14, the axially outer side portions of the pad clips 7a and 7b (the axially outer side portion of the guide plate portion 50, the restraining portion 54), and the axially outer side portion of the return spring 48 (the axially outer side portion of the spring arm portion 61), and the axial cover portion 28 can also be suppressed.

In addition, since the first recessed groove 36 is provided on the axially outer side surface of the axial cover portion 28 to be connected to the opening portion on the axially outer side of the through hole 35, and the width dimension of the first recessed groove 36 is substantially the same as the radial dimension of the opening portion on the axially outer side of the through hole 35, the through hole 35 and the first recessed groove 36 can be smoothly continued, and the opening portion on the axially outer side of the through hole 35 can be made inconspicuous from the outside. In addition, the designability can also be improved by taking in the opening portion on the axially outer side of the through hole 35 as a portion of the design of the design surface.

### Second Embodiment

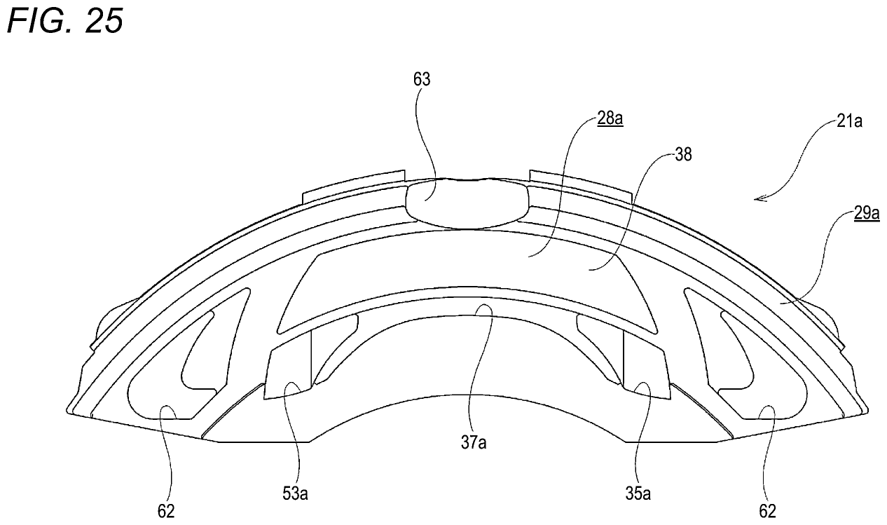

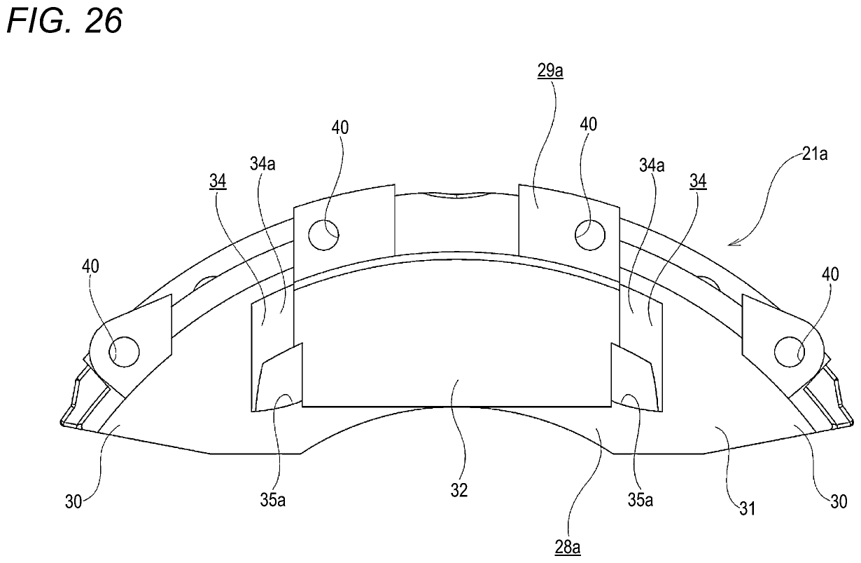

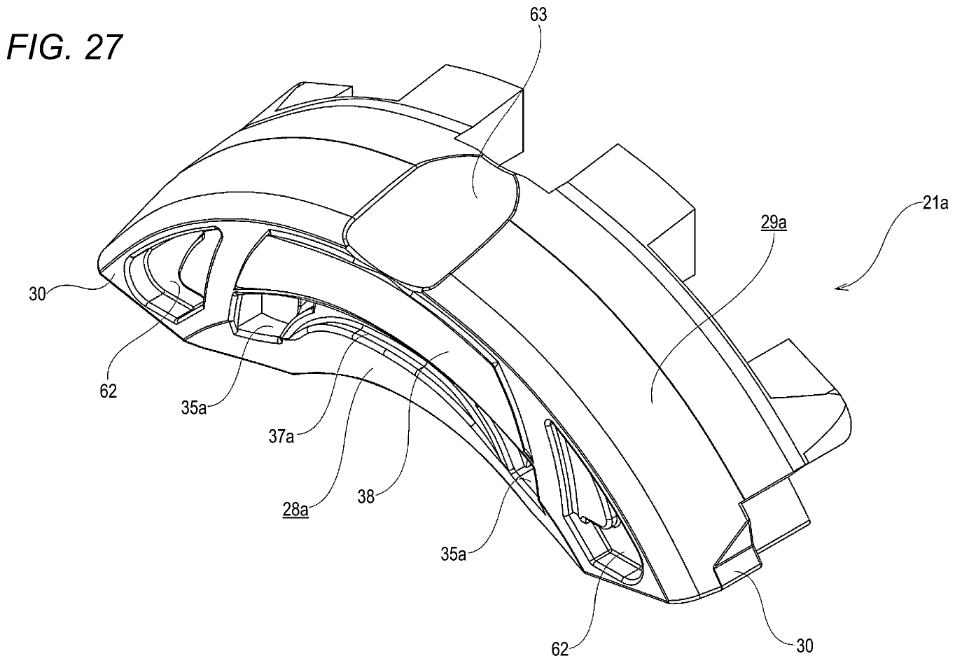

A second embodiment will be described with reference to FIGS. 25 to 27.

In the present embodiment, only a structure of the outer body portion 21a constituting the caliper body 3 is changed from the structure of the first embodiment.

That is, a through hole 35a whose cross-sectional shape changes according to an axial position is formed in the axial cover portion 28a constituting the outer body portion 21a. An inner side surface on a circumferential inner side constituting an inner surface of the through hole 35a according to the present embodiment is inclined in a direction toward a circumferentially inner side, toward an axially outer side. A cross-sectional area (an opening area) of the through hole 35a increases toward the axially outer side. An opening portion on an axially inner side of the through hole 35a has a substantially diamond shape, and an opening portion on an axially outer side of the through hole 35a has a substantially trapezoidal shape or a substantially parallelogram shape.

The axial cover portion 28a includes, on an axially outer side surface thereof, a second recessed groove 37a that connects opening portions on axially outer sides of a pair of through holes 35a in the circumferential direction, but does not include a first recessed groove that extends from the opening portion on the axially outer side of the through hole 35a toward a circumferentially outer side.

The axial cover portion 28a includes a pair of design recessed portions 62 recessed toward the axially inner side on both circumferentially outer side portions of the axially outer side surface. Each of the design recessed portions 62 has a substantially sector shape.

The axial cover portion 28a includes relief recessed portions 34, each of which is configured by the deep recessed portion 34a, on both circumferentially outer side portions of the protruding portion 32 in the axially inner side surface. When wear of the inner pad 4 and the outer pad 5 progresses and the caliper body 3 moves to the axially inner side with respect to the support 2, the axially outer side portions of the pad clips 7a and 7b can be inserted into the relief recessed portion 34. That is, in the case of the present embodiment, even when a shallow recessed portion is omitted from the axially inner side surface of the axial cover portion 28a, it is possible to suppress interference between the axially outer side surface of the outer guide portion 14 and the axially inner side surface (the reference surface 31) of the axial cover portion 28a in a state where the inner pad 4 and the outer pad 5 are fully worn.

A radial cover portion 29a constituting the outer body portion 21a does not include a central window that opens on both radial sides in a circumferential central portion of an outer circumferential surface, and includes a central recessed portion 63 having a concave curved surface shape recessed toward a radially inner side.

In the case of the present embodiment as described above, since the inner side surface on the circumferentially inner side constituting the inner surface of the through hole 35a is inclined in a direction toward the circumferentially inner side, toward the axially outer side, the continuity between the through hole 35a and the second recessed groove 37a can be improved, and the designability can be improved.

Other configurations, operations, and effects are the same as those of the first embodiment.

### Third Embodiment

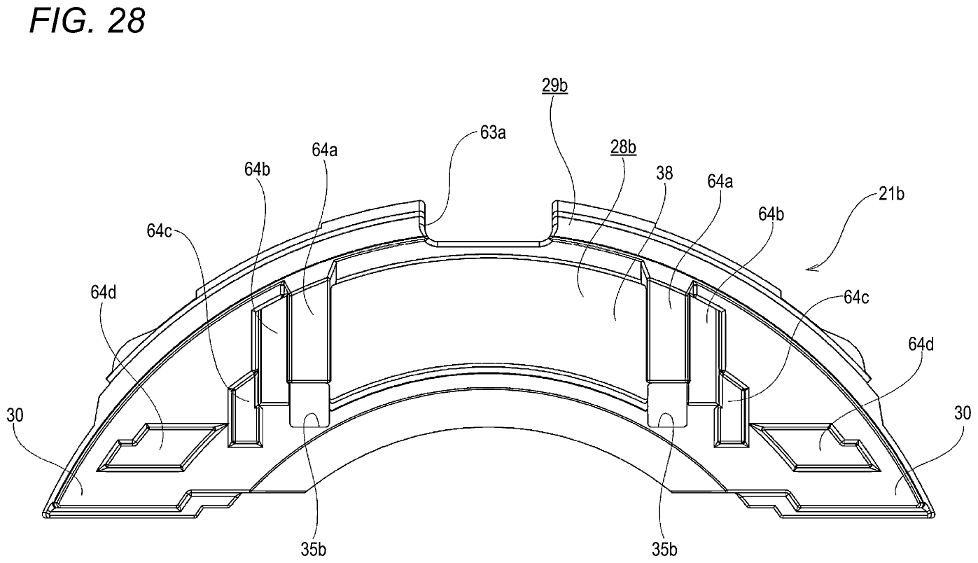

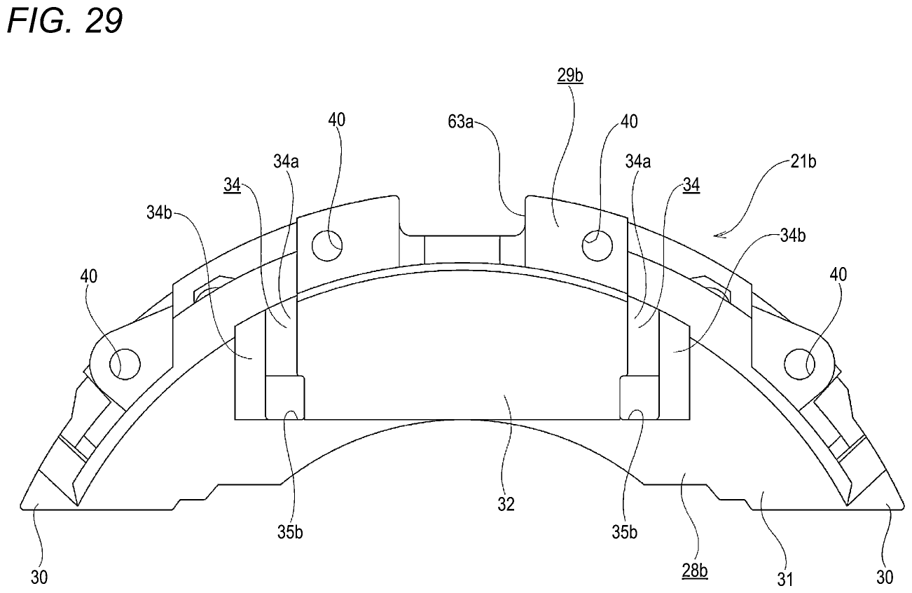

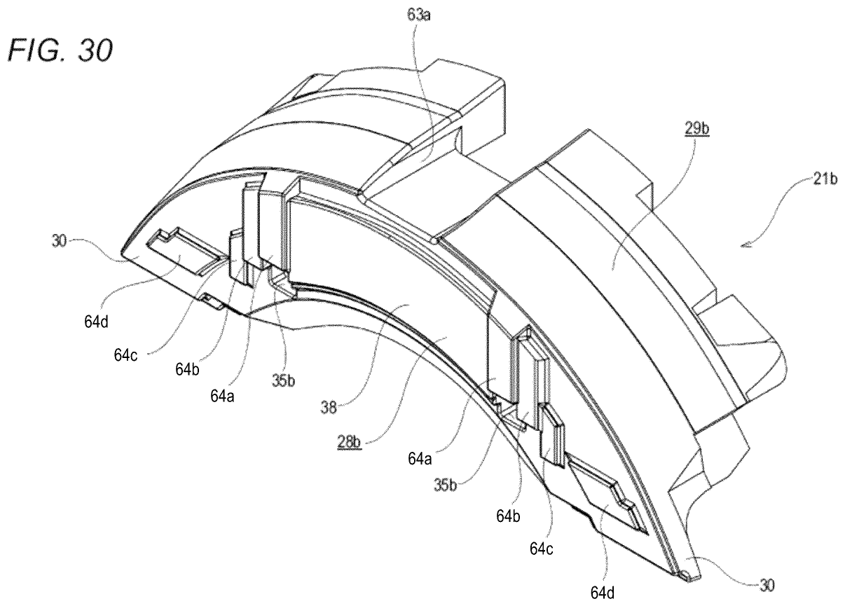

A third embodiment will be described with reference to FIGS. 28 to 30.

In the present embodiment, only a structure of the outer body portion 21b constituting the caliper body 3 is changed from the structure of the first embodiment.

That is, the through hole 35b having a constant cross-sectional shape in the axial direction is formed in the axial cover portion 28b constituting the outer body portion 21b. The through hole 35b is a rectangular hole having a rectangular (substantially square) cross-sectional shape.

The axial cover portion 28b does not include any of a first recessed groove and a second recessed groove connected to the opening portions on the axially outer side of the pair of through holes 35b on an axially outer side surface.

The axial cover portion 28b includes a plurality of (four in the shown embodiment) design convex portions 64a to 64d on both circumferential outer sides with the display portion 38 interposed therebetween. Axially outer side surfaces (distal end surfaces) of the design convex portions 64a to 64d are flat surfaces, and are disposed on the same virtual plane as the display portion 38. The opening portions on the axially outer side of the through holes 35b are surrounded by the display portion 38 and the plurality of design convex portions 64a to 64c. Each of the design convex portions 64a to 64d has a substantially quadrangular shape.

A radial cover portion 29b constituting the outer body portion 21b does not include a central window that opens on both radial sides in a circumferential central portion of an outer circumferential surface, and includes a central recessed portion 63a having a rectangular recessed shape recessed toward a radially inner side.

In the case of the present embodiment as described above, the opening portions on the axially outer side of the through holes 35b are surrounded by the display portion 38 and the plurality of design convex portions 64a to 64c, so that the opening portions can be made inconspicuous from the outside.

Other configurations, operations, and effects are the same as those of the first embodiment.

### Fourth Embodiment

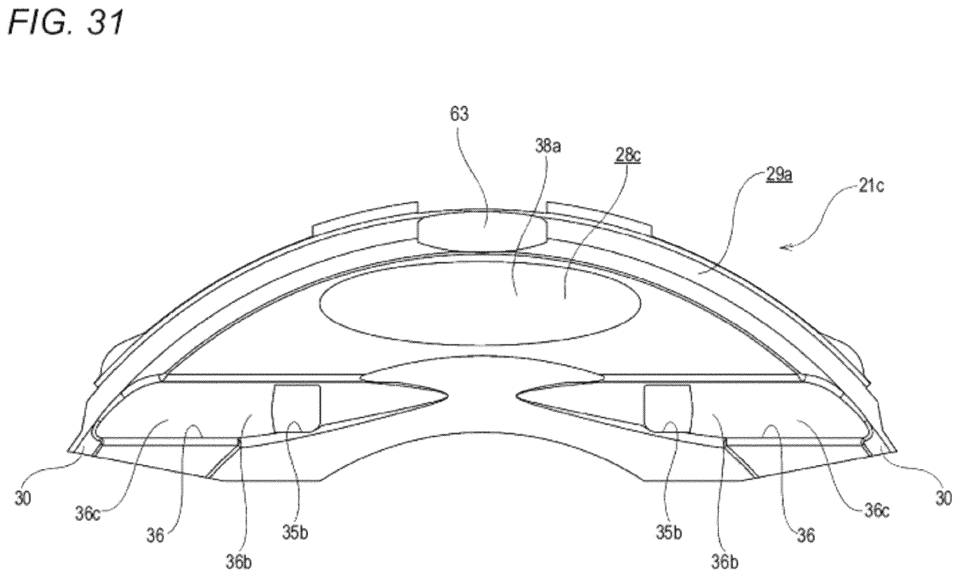

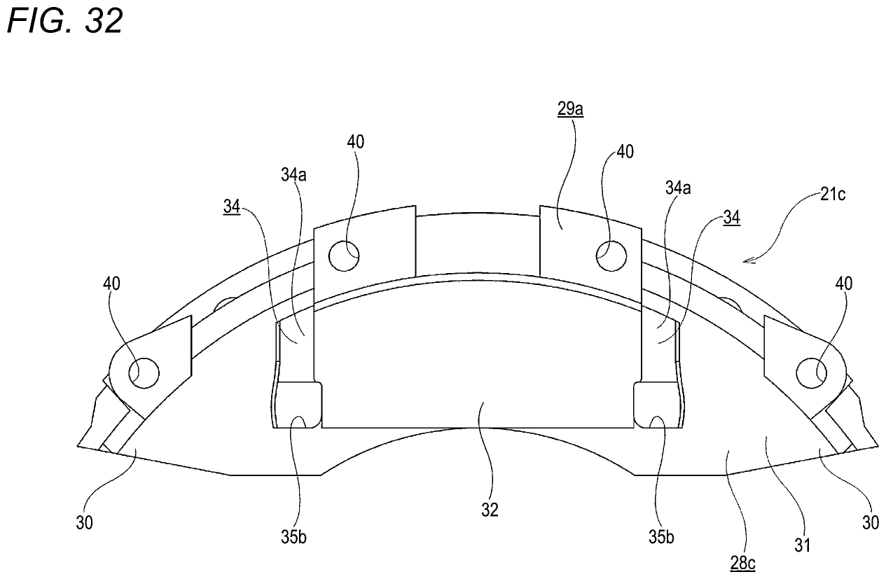

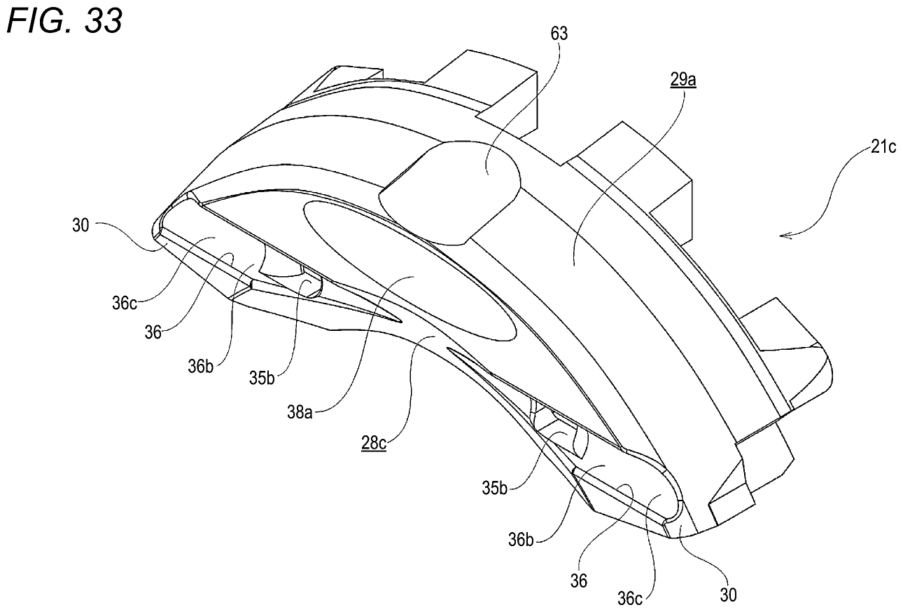

A fourth embodiment will be described with reference to FIGS. 31 to 33.

In the present embodiment, only a structure of an outer body portion 21c constituting the caliper body 3 is changed from the structure of the first embodiment.

Similarly to the structure of the third embodiment, the axial cover portion 28c constituting the outer body portion 21c includes the rectangular through hole 35b having a rectangular (substantially square) cross-sectional shape.

The axial cover portion 28c includes a pair of first recessed grooves 36 connected to the opening portions on the axially outer side of the pair of through holes 35b on an axially outer side surface. The first recessed groove 36 includes only the linear portion 36b that extends linearly in the circumferential direction, and is formed to cross the through hole 35b in the circumferential direction.

The circumferentially outer side end of the first recessed groove 36 (the linear portion 36b) opens to a cylindrical radially outer side surface (an outer circumferential surface) corresponding to a string of the axial cover portion 28c. In addition, a circumferentially inner side end of the first recessed groove 36 (the linear portion 36b) reaches the vicinity of a circumferential central portion of the axially outer side surface of the axial cover portion 28c. Circumferentially inner side ends of the pair of first recessed grooves 36 are separated from each other in the circumferential direction without being joined to each other. A circumferentially inner side portion of the first recessed groove 36 has a tapered shape whose width dimension decreases toward a circumferentially inner side.

The bottom surface 36c of the first recessed groove 36 is not a flat surface but a concave curved surface curved in an arc shape. Specifically, the bottom surface 36c of the first recessed groove 36 is a concave curved surface that is curved in an arc shape such that a width direction intermediate portion is recessed more on an axially inner side than both width direction side portions.

The axial cover portion 28c includes an elliptical display portion 38a usable for displaying a logo or the like on a radially outer side portion of a circumferentially intermediate portion of an axially outer side surface.

Similarly to the structure of the second embodiment, the axial cover portion 28c includes the relief recessed portions 34, each of which is configured by the deep recessed portion 34a, on both circumferentially outer side portions of the protruding portion 32 in an axially inner side surface. When wear of the inner pad 4 and the outer pad 5 progresses and the caliper body 3 moves to the axially inner side with respect to the support 2, the axially outer side portions of the pad clips 7a and 7b can be inserted into the relief recessed portion 34.

The radial cover portion 29a constituting the outer body portion 21c includes the central recessed portion 63 having a concave curved surface shape recessed toward the radially inner side in a circumferential central portion of an outer circumferential surface.

In the case of the present embodiment as described above, since the axial cover portion 28c includes the linear first recessed groove 36 so as to cross the opening portion on the axially outer side of the through hole 35b in the circumferential direction, the opening portion on the axially outer side of the through hole 35b can be made inconspicuous from the outside.

Other configurations, operations, and effects are the same as those of the first embodiment and the second embodiment.

### Fifth Embodiment

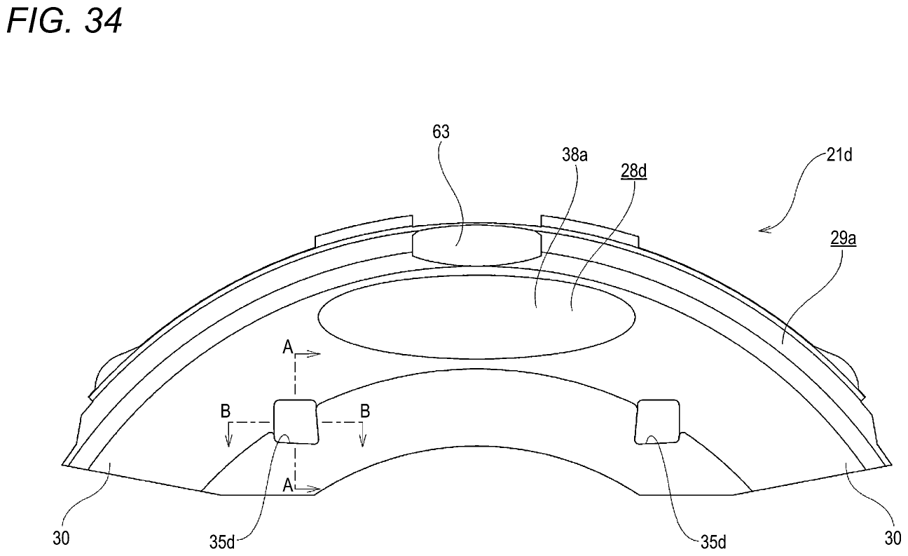

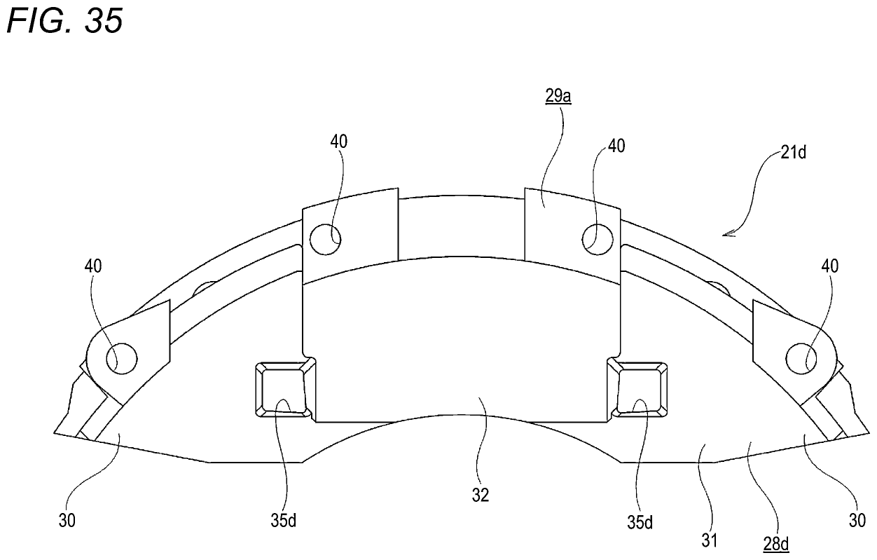

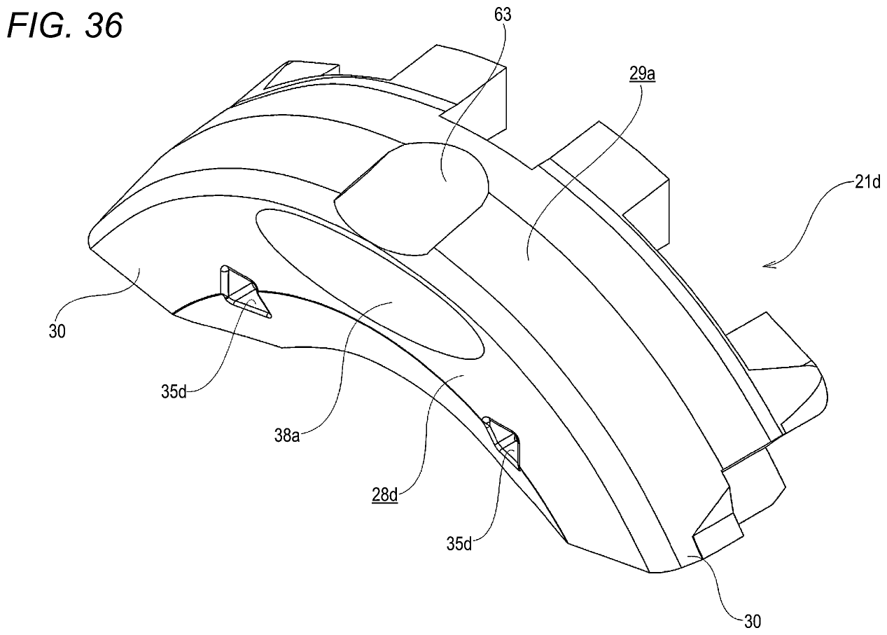

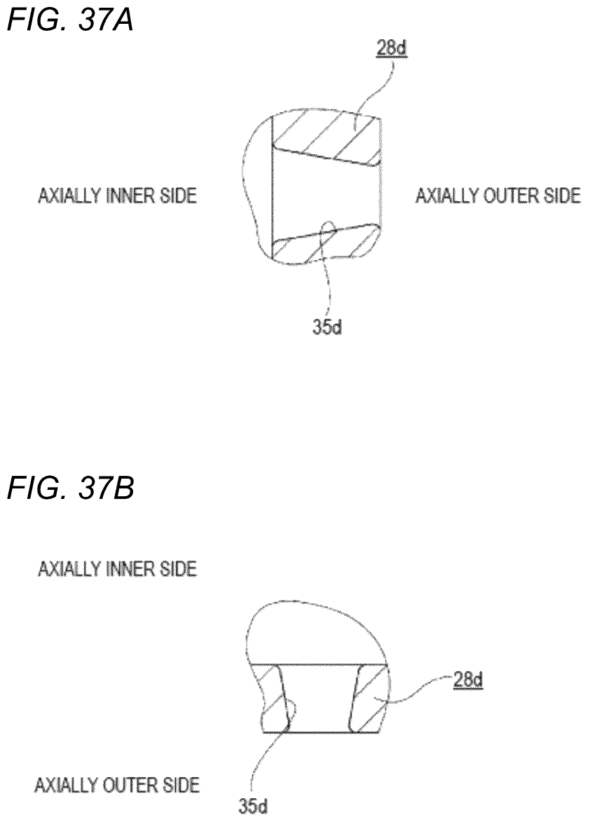

A fifth embodiment will be described with reference to FIGS. 34 to 37.

In the present embodiment, only a structure of the outer body portion 21d constituting the caliper body 3 is changed from the structure of the first embodiment.

That is, the through hole 35d whose cross-sectional shape changes according to an axial position is formed in an axial cover portion 28d constituting the outer body portion 21d. In the shown embodiment, the through hole 35d is a tapered rectangular hole, and a cross-sectional area thereof decreases toward the axially outer side. Accordingly, an opening portion on an axially outer side of the through hole 35d is made small. When the present invention is implemented, a central axis of the through hole may be inclined with respect to the central axis of the rotor.

The axial cover portion 28d does not include any of a first recessed groove and a second recessed groove connected to the opening portions on the axially outer side of the pair of through holes 35d on the axially outer side surface. The axial cover portion 28d includes an elliptical display portion 38a usable for displaying a logo or the like on a radially outer side portion of a circumferentially intermediate portion of the axially outer side surface.

The axial cover portion 28d does not include a relief recessed portion on both circumferentially outer side portions of the protruding portion 32 in the axially inner side surface. That is, in the case of the present embodiment, even when the relief recessed portion is omitted from the axially inner side surface of the axial cover portion 28d, interference between the axially outer side surface of the outer guide portion 14 and the axially inner side surface (the reference surface 31) of the axial cover portion 28d can be suppressed in a state where the inner pad 4 and the outer pad 5 are fully worn, and interference between a portion other than the curl portion 57 of the pad clips 7a and 7b and the axially inner side surface (the reference surface 31) of the axial cover portion 28d can be suppressed.

The radial cover portion 29a constituting the outer body portion 21d includes the central recessed portion 63 having a concave curved surface shape recessed toward the radially inner side in the circumferential central portion of the outer circumferential surface.

In the case of the present embodiment as described above, since the through hole 35d is a tapered rectangular hole whose cross-sectional area decreases toward the axially outer side, it is possible to suppress interference between the through hole 35d and the curl portion 57 even when elastic deformation occurs in the axial cover portion 28d during braking. In addition, since the opening portion on the axially outer side of the through hole 35d can be made small, the opening portion can be made inconspicuous from the outside.

Other configurations, operations, and effects are the same as those of the first embodiment.

Although the embodiments of the present invention have been described above, the present invention is not limited thereto, and can be appropriately changed without departing from the technical concept of the invention. In addition, the structures of the embodiments can be appropriately combined and implemented as long as no contradiction occurs.

In the structures of the embodiments, since a configuration is adopted in which a pad clip is attached to an outer guide portion constituting a support, and a curl portion constituting the pad clip is disposed to protrude most to an axially outer side from an outer guide portion, a through hole into which the curl portion can be inserted is formed in an axial cover portion constituting a caliper body. However, when the present invention is implemented, a portion to be inserted into the through hole formed in the axial cover portion is not limited to the curl portion, and may be a portion of the pad clip disposed on the most axially outer side. Therefore, a formation position and size of the through hole may be changed according to a shape of the pad clip to be used. Further, in a case of adopting a configuration in which the pad clip is not attached to the outer guide portion constituting the support, a portion or all of the outer guide portion may be inserted into the through hole formed in the axial cover portion. In this case, the formation position and size of the through hole may be changed according to a shape of the outer guide portion.

Here, features of the above-described embodiments of the floating disc brake device according to the present invention will be briefly summarized and listed below.

[1]

A floating disc brake device (1) including:
an inner pad (4) configured to be disposed on an axially inner side of a rotor (8);
an outer pad (5) configured to be disposed on an axially outer side of the rotor (8);
a support (2) configured to be fixed to a vehicle body and configured to support the inner pad (4) and the outer pad (5) such that the inner pad (4) and the outer pad (5) are movable in an axial direction; and
a caliper body (3) supported to be movable in the axial direction with respect to the support (2), in which
the support (2) includes an inner guide portion (13) configured to support the inner pad (4) such that the inner pad (4) is movable in the axial direction, and an outer guide portion (14) configured to support the outer pad (5) such that the outer pad (5) is movable in the axial direction, on each of both circumferentially outer side portions,
the caliper body (3) includes a cylinder (23), and includes an inner body portion (20) configured to be disposed on the axially inner side of the rotor (8) and an outer body portion (21, 21a, 21b, 21c, and 21d) configured to press the outer pad (5) during braking, and
the outer body portion (21) includes a through hole (35, 35a, 35b, and 35d) that opens only in the axial direction in at least one of a portion facing the outer guide portion (14) in the axial direction and a portion facing a vicinity of the outer guide portion (14) in the axial direction.

[2]

The floating disc brake device (1) according to [1], further including:
a pad clip (7a and 7b) disposed between the outer pad (5) and the outer guide portion (14), in which
a portion of the pad clip (7a and 7b) is configured to be inserted into the through hole (35, etc.).

[3]

The floating disc brake device (1) according to [2], in which
the through hole (35) has a shape and a size into which the portion of the pad clip (7a and 7b) can be inserted substantially without a gap.

[4]

The floating disc brake device (1) according to any one of [1] to [3], in which
the outer pad (5) includes a protruding ear portion (47b) that protrudes in a circumferential direction,
the outer guide portion (14) includes a guide recessed groove (an outer side guide recessed groove 17) engageable with the ear portion (47b), and
the through hole (35) is provided in a portion facing an internal space of the guide recessed groove (the outer side guide recessed groove 17) in the axial direction.

[5]

The floating disc brake device (1) according to any one of [1] to [4], in which the through hole (35) has a circumferential dimension larger than a radial dimension.

[6]

The floating disc brake device (1) according to any one of [1] to [5], in which
the through hole (35 and 35b) has a substantially polygonal opening shape as viewed in the axial direction.

[7]

The floating disc brake device (1) according to any one of [1] to [6], in which
the through hole (35a and 35d) has a cross-sectional shape that changes according to an axial position.

[8]

The floating disc brake device (1) according to any one of [1] to [7], in which
the outer body portion (21) has a circumferential dimension larger than a circumferential dimension of the support (2).

[9]

The floating disc brake device (1) according to any one of [1] to [8], in which
a recessed groove (a first recessed groove 36) connected to an opening portion of the through hole (35) is provided on an axially outer side surface of the outer body portion (21).

[10]

The floating disc brake device (1) according to [9], in which
the recessed groove (the first recessed groove 36) extends in a circumferential direction.

[11]

The floating disc brake device (1) according to [10], in which
the outer body portion (21) has a substantially arcuate shape as viewed in the axial direction, and
the recessed groove (the first recessed groove 36) opens to a radially inner side surface or a radially outer side surface of the outer body portion (21). [12]

The floating disc brake device (1) according to any one of [9] to [11], in which
a bottom surface (36c) of the recessed groove (the first recessed groove 36) is a convex curved surface that is curved in an arc shape such that a width direction intermediate portion protrudes to an axially outer side with respect to both width direction side portions.

[13]

The floating disc brake device (1) according to any one of [9] to [11], in which
a bottom surface (36c) of the recessed groove (the first recessed groove 36) is a concave curved surface that is curved in an arc shape such that a width direction intermediate portion is recessed on an axially inner side with respect to both width direction side portions.

[14]

The floating disc brake device (1) according to any one of [1] to [13], in which
a central axis of the through hole (35) and a central axis of the rotor (8) are parallel to each other.

[15]

The floating disc brake device (1) according to any one of [1] to [14], in which
the outer body portion (21) has two of the through holes (35).

The present application is based on a Japanese Patent Application (Japanese Patent Application No. 2021-205027) filed on Dec. 17, 2021, and the content thereof is incorporated herein by reference.

### INDUSTRIAL APPLICABILITY

According to the disc brake device of the present invention, it is possible to realize a disc brake device capable of suppressing interference between a pad clip attached to at least one of outer guide portions and the outer guide portions of a support, and an outer body portion of a caliper body.

### REFERENCE SIGNS LIST

1: disc brake device
2: support
3: caliper body
4: inner pad
5: outer pad
6a, 6b: pad clip
7a, 7b: pad clip
8: rotor
9: guide portion
10: inner side circumferential connection portion
11: outer side circumferential connection portion
12: attachment hole
13: inner guide portion
14: outer guide portion
15: caliper guide portion
16: inner side guide recessed groove
17: outer side guide recessed groove
18: protruding portion
19: slide pin
20: inner body portion
21, 21a, 21b, 21c, 21d: outer body portion
22a, 22b: connection member
23: cylinder
24: circumferential arm portion
25: radially protruding portion
26: fixing hole
27: strip-shaped rib
28, 28a, 28b, 28c, 28d: axial cover portion
29, 29a, 29b: radial cover portion
30: blade portion
31: reference surface
32: protruding portion
33: contact convex portion
34: relief recessed portion
34a: deep recessed portion
34b: shallow recessed portion
35, 35a, 35b, 35d: through hole
36: first recessed groove
36a: curved portion
36b: linear portion
36c: bottom surface
37: second recessed groove
38, 38a: display portion
39: groove portion
40: attachment hole
41: central window
42: opening portion
43: boot
44a, 44b: lining
45a, 45b: back plate
46a, 46b: base plate portion
47a, 47b: ear portion
48: return spring
49: clamping portion
50: guide plate portion
51: radial pressing portion
52: circumferential pressing portion
53: spring holding portion
54: restraining portion
55a, 55b: claw piece
56: pressing base plate portion
57: curl portion
58: pressing body portion
59: coil portion
60: locking arm portion
61: spring arm portion
62: design recessed portion
63, 63a: central recessed portion
64a to 64d: design convex portion
65: support hole
100: disc brake device
101: support
102: caliper body
103: inner pad
104: outer pad
105: rotor
106: guide portion
107: circumferential connection portion
108: inner guide portion
109: outer guide portion
110: caliper guide portion
111: support hole
112: outer body portion
113: inner body portion
114: cylinder
115: piston
116: slide pin

1: A floating disc brake device comprising:
an inner pad configured to be disposed on an axially inner side of a rotor;
an outer pad configured to be disposed on an axially outer side of the rotor;
a support configured to be fixed to a vehicle body and configured to support the inner pad and the outer pad such that the inner pad and the outer pad are movable in an axial direction; and
a caliper body supported to be movable in the axial direction with respect to the support, wherein
the support includes an inner guide portion configured to support the inner pad such that the inner pad is movable in the axial direction, and an outer guide portion configured to support the outer pad such that the outer pad is movable in the axial direction, on each of both circumferentially outer side portions,
the caliper body includes a cylinder, and includes an inner body portion configured to be disposed on the axially inner side of the rotor and an outer body portion configured to press the outer pad during braking, and
the outer body portion includes a through hole that opens only in the axial direction in at least one of a portion facing the outer guide portion in the axial direction and a portion facing a vicinity of the outer guide portion in the axial direction.

2: The floating disc brake device according to claim 1, further comprising:
a pad clip disposed between the outer pad and the outer guide portion, wherein
a portion of the pad clip is configured to be inserted into the through hole.

3: The floating disc brake device according to claim 2, wherein
the through hole has a shape and a size into which the portion of the pad clip can be inserted substantially without a gap.

4: The floating disc brake device according to claim 1, wherein
the outer pad includes a protruding ear portion that protrudes in a circumferential direction,
the outer guide portion includes a guide recessed groove engageable with the ear portion, and
the through hole is provided in a portion facing an internal space of the guide recessed groove in the axial direction.

5: The floating disc brake device according to claim 1, wherein
the through hole has a circumferential dimension larger than a radial dimension.

6: The floating disc brake device according to claim 1, wherein
the through hole has a substantially polygonal opening shape as viewed in the axial direction.

7: The floating disc brake device according to claim 1, wherein
the through hole has a cross-sectional shape that changes according to an axial position.

8: The floating disc brake device according to claim 1, wherein
the outer body portion has a circumferential dimension larger than a circumferential dimension of the support.

9: The floating disc brake device according to claim 1, wherein
a recessed groove connected to an opening portion of the through hole is provided on an axially outer side surface of the outer body portion.

10: The floating disc brake device according to claim 9, wherein
the recessed groove extends in a circumferential direction.

11: The floating disc brake device according to claim 10, wherein
the outer body portion has a substantially arcuate shape as viewed in the axial direction, and
the recessed groove opens to a radially inner side surface or a radially outer side surface of the outer body portion.

12: The floating disc brake device according to claim 9, wherein
a bottom surface of the recessed groove is a convex curved surface that is curved in an arc shape such that a width direction intermediate portion protrudes to an axially outer side with respect to both width direction side portions.

13: The floating disc brake device according to claim 9, wherein
a bottom surface of the recessed groove is a concave curved surface that is curved in an arc shape such that a width direction intermediate portion is recessed on an axially inner side with respect to both width direction side portions.

14: The floating disc brake device according to claim 1, wherein
a central axis of the through hole and a central axis of the rotor are parallel to each other.

15: The floating disc brake device according to claim 1, wherein
the outer body portion has two of the through holes.
